(19) United States
(12) Patent Application Publication
(10) Pub. No.: US 2025/0018584 A1
(43) Pub. Date: Jan. 16, 2025

(54) Robotic Article Managing End Effector with Horizontal Support Platform

(71) Applicant: Sarcos Corp., Salt Lake City, UT (US)

(72) Inventors: Fraser M. Smith, Salt Lake City, UT (US); Matthew Torok, Cary, NC (US); Jeffrey Polochak, Pittsburgh, PA (US); David Bonitsky, Pittsburgh, PA (US)

(21) Appl. No.: 18/771,927

(22) Filed: Jul. 12, 2024

Related U.S. Application Data
(60) Provisional application No. 63/513,326, filed on Jul. 12, 2023.

(51) Int. Cl. B25J 15/06; B25J 17/00; B25J 18/02

(52) U.S. Cl. CPC B25J 15/0658; B25J 15/0625; B25J 17/00; B25J 18/02

(57) ABSTRACT

This disclosure sets forth a robotic end effector for acquiring and managing an article, such as an item of luggage. The robotic end effector can include a support bridge and an arm extending away from the support bridge in a first direction, the arm comprising a first support member. The robotic end effector can further include a support platform extending away from the support bridge in the first direction at a position offset from the arm to define a capture volume configured to receive the article between the arm and the support platform. The robotic end effector can further include an article interface system supported by the arm, and comprising an actuatable article engagement device operable to interface with a target article to facilitate movement of the target article in a direction toward the support bridge.

### RELATED APPLICATION

This application claims the benefit of U.S. Provisional Application Ser. No. 63/513,326, filed Jul. 12, 2023, and entitled, “Robotic Article Managing End Effector with Horizontal Support Platform”, which is incorporated by reference in its entirety herein.

### BACKGROUND

In a wide variety of applications, various articles such as boxes, packages, bags, luggage, baggage, goods, and other items or objects need to be collected and acquired to be moved from one location to another. For example, in the shipping industry packages and boxes are frequently moved from one location to another. The locations from/to which such packages are moved can include shelves, floors, surfaces, vehicles, conveyer belts, or any other storage or transportation location commonly used for packages. Similarly, items and goods are often stored in warehouses, shipping yards, rail yards, docks, and need to be retrieved from storage locations before being transported to an end destination via land, air, or sea vehicles.

One such situation in which articles are collected and transported to another location is baggage handling in air travel. International and domestic travel are popular for people all around the globe, for purposes of business, pleasure, or personal reasons. Billions of people around the world travel both internationally and domestically annually. For all forms of travel, particularly air travel, luggage handling and transportation is important for travelers to ensure they have the supplies they need while away from their residence. Furthermore, valuables and gifts, which can often be fragile, are at times transported in luggage during traveling.

Significant resources (e.g., people, machinery, fuel, electricity, etc.) and time are consumed in a process of taking luggage from passengers and transporting the luggage from passengers to a vehicle used to transport people and luggage from a point of origin to a destination. Further time and resources are consumed loading the luggage onto the vehicular transport prior to departure of the vehicle. The resources and time consumed while handling and loading luggage prior to departure can lead to inefficiencies in conserving resources and can cause significant delays in departure times. Such delays can complicate travel arrangements and can limit the amount of departures and travelers that can embark in a certain time frame. Such delays can also be costly, in both time and money, for travelers as well as travel transportation companies.

Similar inefficiencies and resource consumption exist in any shipping, warehouse organization, transportation, or other article handling situations. Furthermore, articles are often handled by one or more individuals, which can lead to injuries, damage to the article, and errors and misdirection in transporting articles to an intended destination. In order to reduce delays, reduce costs, prevent damages, prevent injuries, and decrease errors, it is desirable to develop quicker, more efficient, safer, and less expensive methods, devices, and systems for collecting, transporting, handling, and loading of articles during transportation of the articles from one destination to another.

### BRIEF DESCRIPTION OF THE DRAWINGS

Features and advantages of the invention will be apparent from the detailed description which follows, taken in conjunction with the accompanying drawings, which together illustrate, by way of example, features of the invention; and wherein:

FIG. 1 illustrates a schematic diagram of a robotic end effector in accordance with at least one example of the present disclosure.

FIG. 2 illustrates a trimetric view of a robotic end effector in accordance with at least one example of the present disclosure.

FIG. 3A illustrates an upper perspective view of an actuatable article engagement device of the robotic end effector of FIG. 2.

FIG. 3B illustrates a top view of the actuatable article engagement device of FIG. 3A.

FIG. 3C illustrates a lower perspective view of the actuatable article engagement device of FIG. 3A.

FIG. 3D illustrates a bottom view of the actuatable article engagement device of FIG. 3A.

FIG. 3E illustrates a side view of the actuatable article engagement device of FIG. 3A.

FIG. 3F illustrates a front view of the actuatable article engagement device of FIG. 3A.

FIGS. 4A-4F illustrates various positions and states of the robotic end effector of FIG. 2.

FIG. 5 illustrates various sizes of articles in relation to the robotic end effector of FIG. 2.

FIGS. 6A-6E illustrate various steps of a process of acquiring a target article in accordance with at least one example of the present disclosure using the robotic end effector of FIG. 2.

FIG. 7A illustrates an extensible member in accordance with at least one example of the present disclosure.

FIG. 7B illustrates an extensible member in accordance with at least one example of the present disclosure.

FIG. 7C illustrates an extensible member in accordance with at least one example of the present disclosure.

FIG. 7D illustrates an extensible member in accordance with at least one example of the present disclosure.

FIG. 8A illustrates an extensible member in accordance with at least one example of the present disclosure.

FIG. 8B illustrates an extensible member in accordance with at least one example of the present disclosure.

FIG. 8C illustrates an extensible member in accordance with at least one example of the present disclosure.

FIG. 8D illustrates an extensible member in accordance with at least one example of the present disclosure.

FIG. 9 illustrates an extensible member in accordance with at least one example of the present disclosure.

FIG. 10 illustrates an extensible member in accordance with at least one example of the present disclosure.

FIG. 11 illustrates a partial view of an end effector including an arm and a support platform in accordance with at least one example of the present disclosure.

FIG. 12A illustrates a front elevation view of a suction asset engaged with an article in accordance with at least one example of the present disclosure.

FIG. 12B illustrates a cross-sectional view of the suction asset of FIG. 12A.

FIG. 13 illustrates a partial view of an end effector in accordance with at least one example of the present disclosure.

FIGS. 14A-14C illustrates various positions and configurations of the end effector of FIG. 13.

FIG. 15A illustrates a support platform in accordance with at least one example of the present disclosure.

FIG. 15B illustrates a support platform in accordance with at least one example of the present disclosure.

FIG. 16 illustrates a method of acquiring an article using an end effector in

accordance with at least one example of the present disclosure.

FIG. 17 illustrates a schematic diagram of a computing device in accordance with at least one example of the present disclosure.

FIG. 18 illustrates a computer implemented method of acquiring an article using an end effector in accordance with at least one example of the present disclosure.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness can in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. In contexts where elements are recited to be “substantially aligned with” another element recited herein, it is intended that the recited element is still “substantially aligned with” another element when the element is either in perfect alignment with, or out of alignment by +/−10 degrees with the other element. In contexts where elements are recited to be “substantially parallel” to another element recited herein, it is intended that the recited element is still “substantially parallel” to the other element when the element is either perfectly parallel with, or is angled away from parallel with the other element by +/−10 degrees.

As used herein, “adjacent” refers to the proximity of two structures or elements. Particularly, elements that are identified as being “adjacent” can be either abutting or connected. Such elements can also be near or close to each other without necessarily contacting each other. The exact degree of proximity can in some cases depend on the specific context.

As used herein, the singular forms “a” and, “the” include plural referents unless the context clearly dictates otherwise.

As used herein, the terms “supported on,” “supported by,” or saying that the one element “supports” and/or “is supporting” another element of the devices or systems described herein can refer to direct support indicating direct contact between the two elements, or this can refer to indirect support in which one or more intermediate elements are provided between the elements.

As used herein, the term “end effector” or “robotic end effector” or “robotic article managing end effector” refers to any robotic end effector device, mechanism or system as taught herein, which can be actuatable to acquire and release an article. The end effector can be operable with a robotic positioning member to facilitate movement and spatial positioning of the end effector and an acquired article, which end effector and robotic positioning member can be operable with or part of a support platform, and which end effector, robotic positioning member, and support platform can be operable with or part of an overall robotic article management or handling system. The end effector can be coupled to a robotic positioning member in some examples. The end effector can comprise a configuration that is operable to acquire, grip, grab, grasp, hold, lift, support, release, and/or otherwise manipulate (or any combination of these) an article or object, such as luggage, baggage, a compliant or rigid bag, a suitcase, a duffle bag, a package, a box, or any other types of articles, objects or a collection of these. As example types, the end effector can be a vacuum gripper, a pneumatic gripper, a hydraulic gripper, a servo-electric gripper, an adhesive gripper, a magnetic gripper, an electrostatic, or any type of end effector operable to acquire and release an article.

As used herein, the term “actuator” refers to a component of a system that is operable to be actuated and moved in one or more linear and/or rotational degrees of freedom to cause movement of one or more other structures or components of the system, or any articles being handled by the system. Any actuator described herein can be an electric actuator (e.g., an electric motor), a pneumatic actuator, a hydraulic actuator, or any other known actuator type capable of causing movement of one or more structures or components. Example actuators are described below, and shown in the drawings.

As used herein, the term “rotational actuator” refers to a type of actuator that is operable to move any structure, component, or element in a rotational degree of freedom, whether or not the rotational actuator itself operates by linear motion or rotational motion. For example, linear motion within an actuator can be translated to rotational motion using intermediate elements. Therefore, even if the actuator moves linearly, it can be considered a rotational actuator if it is used to move a structure, component, or element rotationally.

As used herein, the term “linear actuator” refers to a type of actuator that is operable to move any structure, component, or element in a linear direction, whether or not the linear actuator itself operates by linear motion or rotational motion. For example, rotational motion within an actuator can be translated to linear motion using intermediate elements. Therefore, even if the actuator itself moves rotationally, it can be considered a linear actuator if it is used to move a structure, component, or element linearly.

As used herein, the term “extendable arm” refers to one or more structural support members of the robotic end effector in support of an article interface system of the robotic end effector, and that is/are extendable and retractable to facilitate movement of the article interface system between two or more spatially separated points in three-dimensional space. In one example, an extendable arm can be configured to extend and retract linearly (e.g., a structural support member can be caused to move or translate bi-directionally relative to another structural support member along an axis; or two or more jointed telescoping structural support members can be caused to extend and retract relative to one another along an axis; or other configurations). In another example, an extendable arm can comprise one or more jointed structural support members coupled in series via joints that can be caused to rotate relative to one another about respective joint rotational axes to move the structural support members and the article interface system between the two or more spatially separated points. In another example, an extendable arm can comprise any combination of structural support members and linear and rotational joints that facilitate movement in multiple degrees of freedom to move the article interface system between the two or more spatially separated points. Depending upon the configuration of the extendable arm and the location of the two spatially separated points, movement of the article interface system between the two spatially separated points via the extendable arm can be along a line, a curve or arc, or any combination of these.

As used herein, the term “collective forces” refers to one or more forces acting on a target article, with such forces being separate from and outside of any forces acting on the article by the robotic end effector. Collective forces acting on the target article can include gravitational forces acting on the article, stiction between the article and adjacent articles or other surfaces in contact with one or more surfaces of the target article (e.g., articles or support surfaces from one or more structures that may be underneath or to one or more sides of the target article, etc.), friction between the article and other structures or elements in contact with one or more surfaces of the article, and/or compressive forces acting on the article from other articles, elements, or surfaces surrounding the article.

As used herein, the term “article interface system” refers to a system of a robotic end effector device/system that is operable to interface with an article and manipulate and/or move the article into engagement with a support platform. In one example, the article interface system can be supported by and moveable via an extendable arm of the robotic end effector.

As used herein, the term “actuatable article engagement device” refers to a component or element of an article interface system of a robotic end effector that is configured and operable to be actuated to interface with (i.e., come in contact with) an article and to facilitate manipulation and/or movement of the article into engagement with a support platform of the robotic end effector.

As used herein, the term “robotic positioning member” refers to a robotic device or system operable to couple and provide support to the robotic end effector to effectuate movement and spatial positioning of the end effector (and any captured or acquired article) in one or more degrees of freedom, thereby being able to position the robotic end effector in any desired position. The robotic positioning member can comprise a robotic arm supported about a support platform (e.g., a vehicle, a ground surface, or other structural support). In one example, the robotic positioning member can be configured as a selective compliance articulated robot arm (SCARA) comprising two or more revolute joints at which support members of a plurality of support members are moveably coupled to each other via respective actuators. The robotic positioning member can comprise other robotic arm configurations having support members coupled via actuatable joints. In another example, the robotic positioning member can comprise a boom (e.g., a boom structure moveable in one or more degrees of freedom via a plurality support members and actuatable joints), such as a telescoping boom, an articulating boom, or a combination of these, which boom can be supported about a support platform similar to the robotic arm discussed above. In another example, the robotic positioning member can comprise an actuatable post or tower. The post or tower can comprise one or more moveable portions that facilitate positioning of the end effector in multiple degrees of freedom, such as in one, two, three, four, five, and/or six degrees of freedom or any combination of these. For example, the post or tower can comprise a moveable portion that facilitates positioning of the end effector along a horizontal axis relative to ground (e.g., one or more rotational members supported about a second structural member, wherein the rotational member(s) is/are rotatable about an axis normal to ground), one or more moveable portions that facilitate positioning of the end effector along a vertical axis relative to ground (e.g., telescoping members, or one or more other extensible members), or a combination of these. The post or tower can further comprise one or more jointed structural members capable of providing rotation of the end effector in one or more rotational degrees of freedom (e.g., structural members that rotate relative to one another). Those skilled in the art will recognize other robotic systems or devices that can support the robotic end effector to achieve its intended function of acquiring and managing articles. The robotic positioning member can further comprise a robotic end effector interface operable to interface with and facilitate the coupling of a robotic end effector.

As used herein, the term “robotic positioning member interface” refers to that part of the robotic end effector that is operable to interface with the end effector interface of the robotic positioning member to facilitate coupling of the robotic end effector to the robotic positioning member. Generally speaking, the robotic positioning member interface can include both mechanical robotic positioning member interface components (e.g., one or more interfacing members having one or more interfacing surfaces) and electrical robotic positioning member interface components (e.g., wired (e.g., physical connector components) and/or wireless (e.g., wireless transmitting/receiving components) electrical connection components) that facilitate both mechanical and electrical operational functionality of the robotic end effector. The mechanical robotic positioning member interfaces can include any mechanical coupling devices, objects or systems that function and operate to facilitate the mechanical coupling of the end effector to the robotic positioning member, such that the end effector is suitably supported for its intended operation. The electrical robotic positioning member interfaces can include any type of electrical and/or electromechanical connections that function and operate to facilitate the electrical connection of any electrical devices, objects, systems, computers, controllers, electronics components, actuators, sensors, etc. that operate within (i.e., exist in or on) the end effector to any suitably configured external (“external” meaning not part of the end effector) electrical objects, devices, systems intended to enable electrical functionality of the end effector as intended. Such external electrical objects, devices, and/or systems can comprise one or more electrical interfaces that can be configured to interface with the electrical robotic positioning member interfaces of the end effector. Such electrical interfaces of the external electrical objects, devices and/or systems can include, but are not limited to, wired connections, wireless network connections, any others, and any combination of these. Such electrical interfaces can be supported on or be part of the robotic positioning member, the support platform, and/or can be part of an external electrical object or system (e.g., a computer, server) remotely located from the end effector and any support platform coupling the end effector, wherein the external or remote electrical object/system is in electrical communication with the robotic positioning member, the support platform and/or the end effector (e.g., via a wired or wireless network).

As used herein, the term “friction enhancing element” refers to any element that is made part of, used on or added to a supporting surface for the purpose of enhancing friction (e.g., increasing a coefficient of static and/or kinetic friction) between the supporting surface and another surface upon being brought into contact with one another. In some examples, the friction enhancing element can comprise one or more protrusions, micro spines, teeth, or any other projecting structures, or any combination of these, formed into or extending from a supporting surface. These can be integrally formed with, applied to, or otherwise made part of the surface or substrate, and they can comprise the same material as or a different material from the supporting surface. In another example, the friction enhancing element can comprise a coating, adhesive, material, or other element applied to a surface. The friction enhancing element can be configured to mechanically interface with a surface of an article to increase friction and/or grip between the article and the surface in support of the friction enhancing element.

As used herein, the term “engagement force” refers to an axial force measured along an axis oriented in a direction of the engagement of the article with a support platform and/or article interface system, a torque imparted on the support platform by engagement of the article with the support platform, or any combination or components thereof. The engagement force can indicate a force applied between the article and the support platform and/or the article and the article interface system upon either of both of these being caused to come into contact with the article.

As used herein, the term “state of acquisition” refers to the state of the target article as it is fully engaged with the support platform and fully captured by the end effector, such that the acquired target article is fully supported by the end effector in that all collective external forces acting on the target article are overcome and countered that might otherwise cause the target article to inadvertently release from the end effector. In this state, the acquired target article can be moved and manipulated by the end effector from one location to another and intentionally released when needed or desired.

As used herein, the term “biasing member” refers to any type of device, member, system, mechanism, etc. having or providing a spring or spring-like function (i.e., that comprises an element of elasticity and that possess an elastic modulus (e.g., Young's modulus)) and that is capable of applying a force that acts on an object, wherein the biasing member is capable of storing energy when compressed and releasing energy when the compressing force is removed, or at least partially decreased.

As used herein, the term “mobile platform” refers to a manned or unmanned vehicle operable to support and to facilitate controlled locomotion of a robotic positioning member and the robotic end effector coupled thereto within an environment.

An initial overview of the inventive concepts is provided below and then specific examples are described in further detail later. This initial summary is intended to aid readers in understanding the examples more quickly, but is not intended to identify key features.

Disclosed herein, according to at least one example, is a robotic end effector for acquiring and managing an article. The robotic end effector can include a support bridge. The robotic end effector can further include an arm extending away from the support bridge in a first direction, the arm comprising a first support member. The robotic end effector can further include a support platform extending away from the support bridge in the first direction at a position offset from the arm to define a capture volume configured to receive the article between the arm and the support platform. The robotic end effector can further include an article interface system supported by the arm, and comprising an actuatable article engagement device operable to interface with a target article to facilitate movement of the target article. Movement can be to lift all or part of the target article to facilitate additional capture by the robotic end effector. Movement can also be in a direction toward the support bridge.

Additionally, disclosed herein, according to at least one example, is a method for acquiring an article. The method for acquiring the article can include bringing the article and a robotic end effector for acquiring and managing the article into proximity with each other. The robotic end effector can include a support bridge. The robotic end effector can further include an arm extending away from the support bridge in a first direction, the arm including a first support member. The robotic end effector can further include a support platform extending away from the support bridge in the first direction at a position offset from the arm to define a capture volume configured to receive the article between the arm and the support platform. The method can include operating an article interface system supported by the arm. The article interface system can include an actuatable article engagement device operable to interface with a target article to facilitate movement of the target article, such as to lift at least a portion of the target article, and/or to move the target article in a direction toward the support bridge. Operating the article interface system can include moving the actuatable article engagement device from an initial position to a first position relative to the target article in which an article interface surface of the actuatable article engagement device engages with the target article. Operating the article interface system can further include actuating the actuatable article engagement device to act upon the target article, such as to lift at least a portion of the target article, and/or to move the target article toward the support platform until a state of acquisition is achieved, in which the forces acting on the article from the end effector are sufficient to counter collective forces acting on the article.

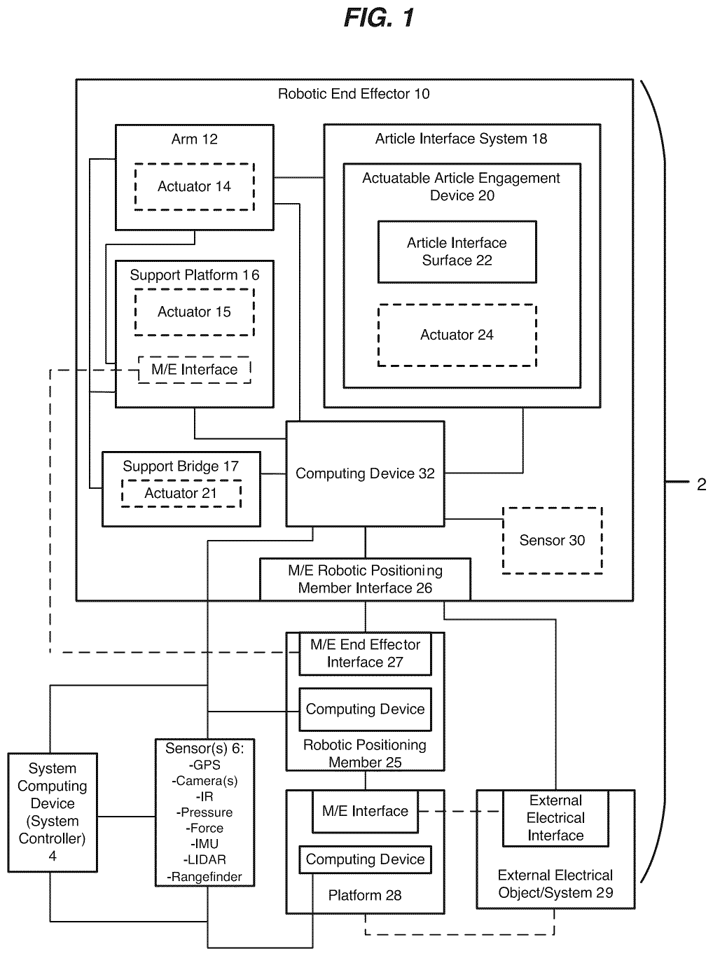

To further describe the present technology, examples are now provided with reference to the figures. FIG. 1 illustrates a schematic of a robotic end effector 10 operable with a robotic positioning member 25 as part of an overall robotic article management system 2, the robotic end effector 10 being configured and operable to acquire and manage an article according to at least one example of the disclosure. FIG. 1 is intended to comprise elements common to, and to be generic to, all of the embodiments discussed herein, although some embodiments may comprise additional elements. The article can be any object to be moved, manipulated, and/or captured, such as luggage, baggage, a suitcase, a bag, a duffle bag, package, box, other types of luggage, or any other similar objects. As illustrated the end effector 10 can include an arm 12 comprising a first support member. The first support member can be a rigid structure or arm configured to support other structures. Optionally, the arm 12 can be an extendable arm comprising a plurality of links or support members and associated joints that are extendable or moveable relative to each other by operation of one or more actuators, such as, optionally, an actuator 14, operable to cause extension of the arm 12 in at least one degree of freedom. The extendable arm can comprise a selective compliance articulated robot arm (SCARA) configuration, a telescoping configuration in which links or support members are telescopically nested or supported by one another to facilitate extension and retraction of the support members relative to each other. In short, the extendable arm can be in any configuration that is operable to facilitate extension or retraction of the extendable arm without any intended limitation. The first support member of the arm 12 can be one of the support members or links of the extendable arm.

The actuator 14 can optionally be two or more actuators with at least one of the actuators being operable to extend the arm 12 in at least one degree of freedom and another of the actuators being operable to induce vibration of the arm 12 and/or any of the support platform 16, the support bridge 17, and/or the article interface system 18 that are coupled to the arm 12. In another example, both the extension and the vibration of the arm 12 can be accomplished using only the single actuator 14 by providing the actuator 14 with a vibration mode. The arm 12 can have any structure without limitation and various example structures of the arm 12 are described herein.

The end effector 10 can further include a support platform 16 operable to receive and support an article being acquired by the end effector 10. The support platform 16 can comprise at least one support structure operable to receive and support the article. Optionally, the support platform 16 can be extendable and can comprising a plurality of links and/or support members and/or extensible members having associated joints that are extendable or moveable relative to each other by operation of one or more actuators, such as, optionally, an actuator 15, operable to cause extension of an extensible member of the support platform 16 in at least one degree of freedom. The actuator 15 can optionally be two or more actuators with at least one of the actuators being operable to extend the extensible member of the support platform 16 and another of the actuators being operable to induce vibration of the support platform 16, and/or any of the arm 12, the support bridge 17, and/or the article interface system 18 that are coupled to the support platform 16. In another example, both the extension and the vibration of the support platform 16 can be accomplished using a single actuator 15 by providing the actuator 15 with a vibration mode. Various structures can operate as the support platform 16 and examples of such structures are described herein.

The end effector 10 can further include an article interface system 18 supported by the arm 12, such as on an end of the arm 12, and including an actuatable article engagement device 20 comprising an article interface surface 22. The actuatable article engagement device 20 can be operable to interface with the article to facilitate movement of the article, such as to lift at least a portion of the target article, and/or to move the target article toward the support platform 16. The article interface system 18 can optionally be actuated by an actuator 24 to move the actuatable article engagement device 20 with its article interface surface 22 into contact with the article to drive the article in a direction toward the support platform 16, or to create interaction forces (e.g., through suction or otherwise) to act on the article in order to bring the article into contact with the actuatable article engagement device 20. The actuator 24 can optionally be two or more actuators with at least one of the actuators being operable to actuate the actuatable article engagement device 20 and another of the actuators being operable to induce vibration of the article interface system 18 and/or any of the support platform 16, the arm 12, and/or the support bridge 17 that are coupled to the article interface system 18. In another example, both the operation and the vibration of the article interface system 18 can alternatively be accomplished using a single actuator 24 by operating the actuator 24 in a vibration mode. Various examples of the article interface system 18, the actuatable article interface device 20, and the article interface surface 22 are described herein.

The end effector 10 can further include a robotic positioning member interface 26 that comprises at least one of a mechanical robotic positioning member interface or an electrical robotic positioning member interface (i.e., an M/E end effector interface, meaning at least one of these alone, or both of these in combination), and that facilitates the mechanical and/or electrical coupling of the end effector 10 to a robotic positioning member 25 supported by a platform 28, the robotic positioning member 25 having a suitably configured mechanical and/or electrical (i.e., M/E) end effector interface 27, thus facilitating and enabling the mechanical and/or electrical operational aspects of the end effector 10. In one example, the robotic positioning member 25 can comprise just a mechanical end effector interface 27 that facilitates the mechanical coupling of the end effector 10 to the robotic positioning member 25 via the robotic positioning member interface 26 of the end effector 10. In another example, the robotic positioning member 25 can comprise both a mechanical end effector interface 27 and an electrical end effector interface 27 that facilitates both the mechanical and electrical coupling of the end effector 10 to the robotic positioning member 25 via the robotic positioning member interface 26 of the end effector 10. In some examples, the robotic positioning member interface 26 of the end effector 10 can alternatively or additionally facilitate the electrical connection or coupling of the end effector 10 to an external object or system 29 (“external” meaning the object or system 29 is not part of the end effector 10), such as a computer or server system, via an electrical interface of the external object or system 29. Such an external object or system 29 can further be electrically connected to or in electrical communication with the robotic positioning member 25 and/or the platform 28 via a similar electrical interface between these, wherein the end effector 10, the robotic positioning member 25, the platform 28, and the external electrical object/system 29 are all in electrical communication with one another. The term “electrical communication” refers to the potential for and the actual of at least one of signal transmission, data (e.g., text, audio, video data, or any combination of these) transmission, power transmission, or any others as will be recognized by those skilled in the art. This can be accomplished over at least one of wired or wireless connections (i.e., one or the other alone, or both of these in combination).

The robotic positioning member interface 26 of the end effector 10 and the end effector interface 27 of the robotic positioning member 25 can each comprise respective one or more interfacing members having one or more interfacing surfaces that can come together to engage, join, connect, link, interlock, couple, or otherwise interface with one another. The robotic positioning member interface 26 of the end effector 10 and the end effector interface 27 of the robotic positioning member 25 can further comprise one or more actuatable joints that facilitate relative movement between these (e.g., a bi-directional rotational joint, a multi-degree of freedom translational and rotational joint, or others).

The robotic positioning member 25 can comprise any robotic system capable of being moved or manipulated (i.e., actuated) relative to the platform 28 to position the end effector 10 in a desired position (thus the end effector 10 also being moveable relative to the platform 28), such as in a position to acquire an article, in one or more positions to move or manipulate the article, and a position to release an acquired article. In one example, the robotic positioning member 25 can comprise an actuatable robotic arm having one or more actuatable joints capable of facilitating movement of the robotic arm in more degrees of freedom, thereby being able to position the end effector 10 into any desired position. In another example, the robotic positioning member 25 can comprise an actuatable post or tower. The post or tower can comprise one or more moveable portions that facilitate positioning of the end effector 10 in multiple degrees of freedom, such as in one, two, three, four, five, and/or six degrees of freedom or any combination of these. For example, the post or tower can comprise a moveable portion that facilitates positioning of the end effector along a horizontal axis relative to ground (e.g., one or more rotational members supported about a second structural member, wherein the rotational member(s) is/are rotatable about an axis normal to ground), one or more moveable portions that facilitate positioning of the end effector along a vertical axis relative to ground (e.g., telescoping members, or one or more other extensible members), or a combination of these. The post or tower can further comprise one or more jointed structural members capable of providing rotation of the end effector in one or more rotational degrees of freedom (e.g., structural members that rotate relative to one another). Of course, other types of robotic positioning members 25 having different configurations will be apparent to those skilled in the art, and such are contemplated herein.

The platform 28 can be any object, structure, system, or machine operable to provide at least one of structural or electrical and general operational support for the robotic positioning member 25 and the end effector 10. In one example, the platform 28 can comprise a moveable object, structure, system, or machine having the robotic positioning member 25 supported thereby or thereon to which the end effector 10 is coupled, connected or otherwise attached, such as a moveable robot (e.g., a humanoid or other type of robot), a wearable exoskeleton, a mobile platform (e.g., a vehicle, cart, truck, water craft, etc. that is operable to move about an environment), or any other moveable object, structure, system or machine as will be apparent to those skilled in the art. In another example, the platform 28 can comprise a stationary object, structure, system or platform having the robotic positioning member 25 supported thereon or thereby to which the end effector 10 is coupled, connected or otherwise attached, such as a post, tower, a structure or floor or a building, a frame or other assembled structure, or any other stationary object, structure, system or platform as will be apparent to those skilled in the art. The end effector 10 can be coupled, joined, connected or otherwise attached to the robotic positioning member 25 supported by the platform 28 via the respective interfaces discussed above, and by any known coupling means (e.g., screws, bolts, adhesive, brackets, or more complex mechanical systems or mechanisms, etc.) without any intended limitation. More specifically, the robotic positioning member interface 26 of the end effector 10 and the end effector interface of the robotic positing member 25 can be operable with any type of coupling means operable to facilitate the coupling, connection, or otherwise attachment of the end effector 10 to the robotic positioning member 25 via their respective interfaces.

In one specific example, the end effector 10 can comprise a baggage managing end effector type that can be configured to acquire and manipulate or move articles in the form of bags or baggage used by passengers for air or ground and/or water travel, and the platform 28 can comprise a mobile vehicle or platform, such as a utility vehicle (e.g., tow tractor) operating on the tarmac of an airport configured for baggage handling and movement (e.g., the transport of baggage to and from one location to another). The utility vehicle can be in support of the robotic positioning member 25 in the form of an actuatable robotic arm, wherein the utility vehicle can transport the robotic arm and the baggage managing end effector from location to location (macro positioning of the baggage managing end effector), and wherein the robotic arm can then further move and position the end effector into any desired position, such as for baggage acquisition or release (micro positioning of the end effector 10).

The support bridge 17 can be coupled to the arm 12, the article interface system 18, the support platform 16, or a separate structure of the end effector 10. In another example, the support platform 16 can be coupled directly to the robotic positioning member 25 via the interfaces of these elements (see dotted lines between the interface of the support platform 16 and the robotic positioning member 25). This can be accomplished via a separate mechanical and/or electrical interface (see M/E interface of support platform 16) shown in dotted lines) designed and operable to mechanically and/or electrically couple the support platform 16 directly to the robotic positioning member 25.

The arm 12 and/or the article interface system 18 can be positionable to facilitate displacement of the article and to apply one or more engagement forces between the article and the support platform 16. The end effector 10 can optionally include one or more sensors, such as a sensor 30 (e.g., a load, pressure, position sensor, suction, or other type of sensor), operable with at least one of the support platform 16 or the arm 12, wherein the sensor 30 and any other sensors can be operable to measure or be used to derive an engagement force acting on the article, a pressure within a volume of a suitably configured capture device, a suction force acting on the article, or a position of one or more displaceable elements of a suitably configured end effector to indicate a state or condition of the article as acted upon by the end effector 10, and if/when a state of acquisition of the article within the support platform 16 has been achieved. The sensor 30 and any other sensors can be placed anywhere on the end effector 10 (e.g., on the article interface system 18, the arm 12, the support platform 16, the article interface surface 22, and/or any joints or actuators), where the sensor 30 and any other sensors can measure the engagement force between the article and the support platform 16, the pressure within the volume, suction force, or the position of any element of the end effector 10.

Using sensor 30 as an example, the sensor 30 can operate to sense certain levels of forces and loads between the article and the support platform 16 that indicate a state of the article relative to the support platform 16 in the end effector 10. For example, the article interface system 18, the arm 12, the support platform 16, and/or the support bridge 17, or any elements thereof, can be configured to transition from one position or state to another relative to the article upon the sensor 30 detecting a threshold force as the article is caused to engage the support platform 16 or the article interface surface 22. Furthermore, a state of acquisition of the article can be indicated to be achieved upon the sensor 30 detecting a force meeting or exceeding a predetermined acquisition threshold where the forces acting on the article from the end effector 10 are sufficient to counter collective outside forces acting on the article.

The end effector 10 can further include a computing device 32 in communication with various components of the end effector 10 and comprising at least a processor, and a memory device configured to store instructions that can be carried out by the processor to operate the various functions of the end effector 10, namely in one example, to facilitate the autonomous operation of the robotic end effector 10. The computing device 32 can be otherwise known as a controller. Additional disclosure regarding exemplary robotic end effectors (such as end effector 10) and the computing device 32 in control of the end effector 10 are found below.

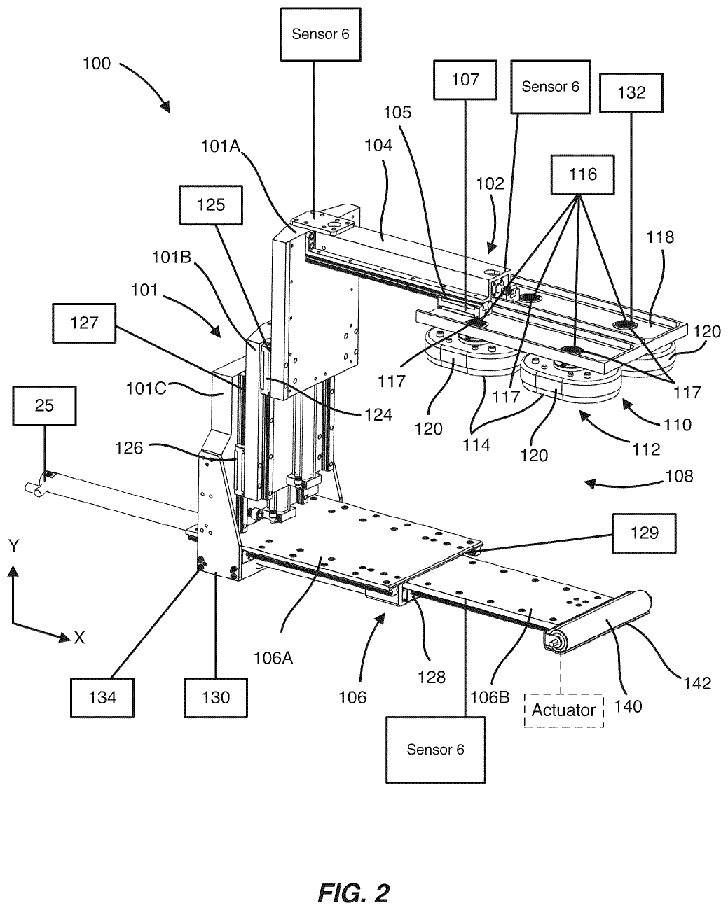

Various examples of robotic end effectors based on the basic end effector 10 schematically shown in FIG. 1 are described below with reference to the figures. FIG. 2 illustrates a trimetric view of a robotic end effector 100 in accordance with an example of the present disclosure. The end effector 100 can be coupled to the robotic positioning member 25. The end effector 100 can be configured to acquire, move, lift, manage, or otherwise manipulate a target article TA. In the example shown, the end effector 100 can be configured as a baggage management type of end effector, and the target article TA can be a piece of luggage or baggage commonly used for traveling. However, it is to be understood that the end effector 100 can be other types, and that the article could be any other item to be acquired and lifted from a first location, and then moved to and released at a different or second location, without limitation. As a specific, non-limiting example, the end effector 100 can be used with articles that are commonly loaded on to a transport or vehicle (e.g., airplane, train, bus, ship/boat) for humans or that are cargo.

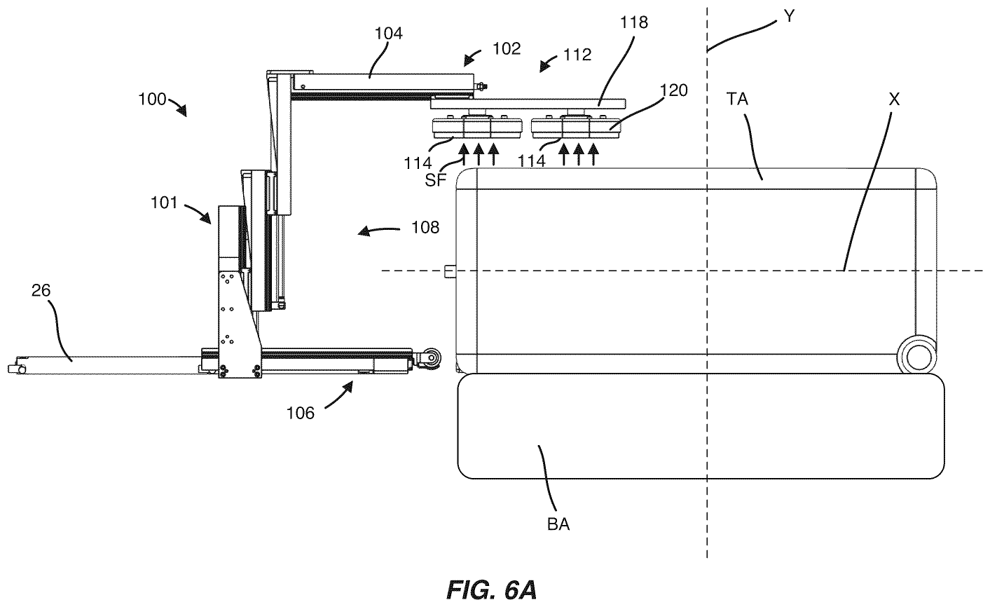

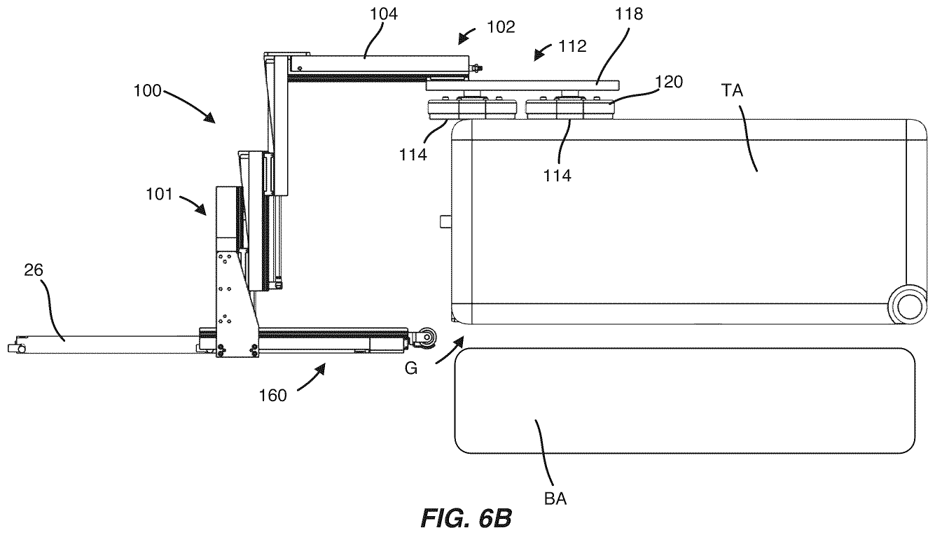

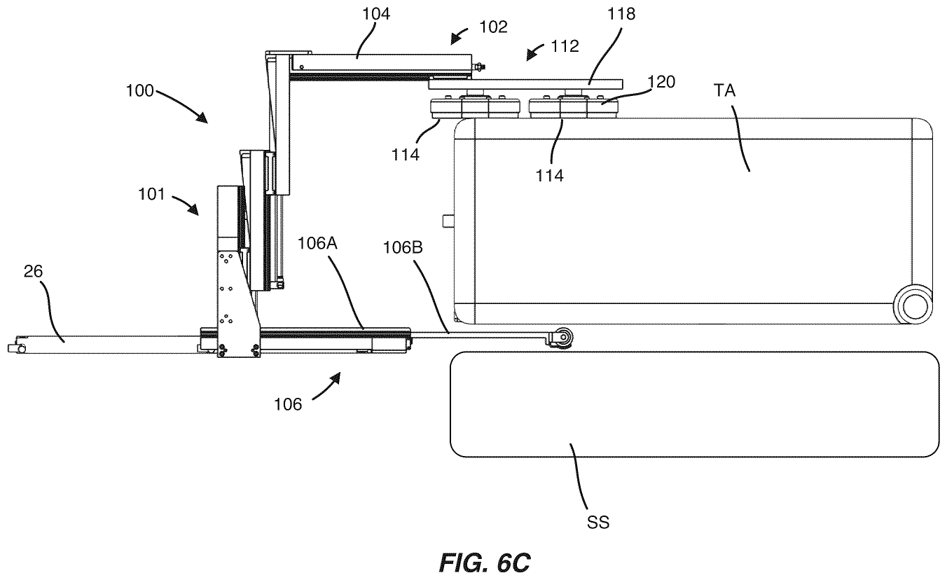

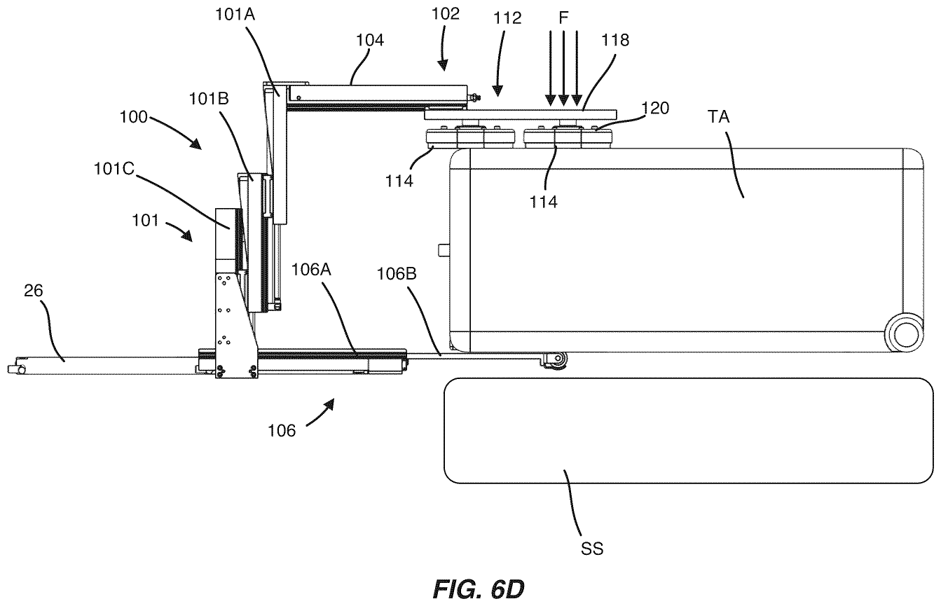

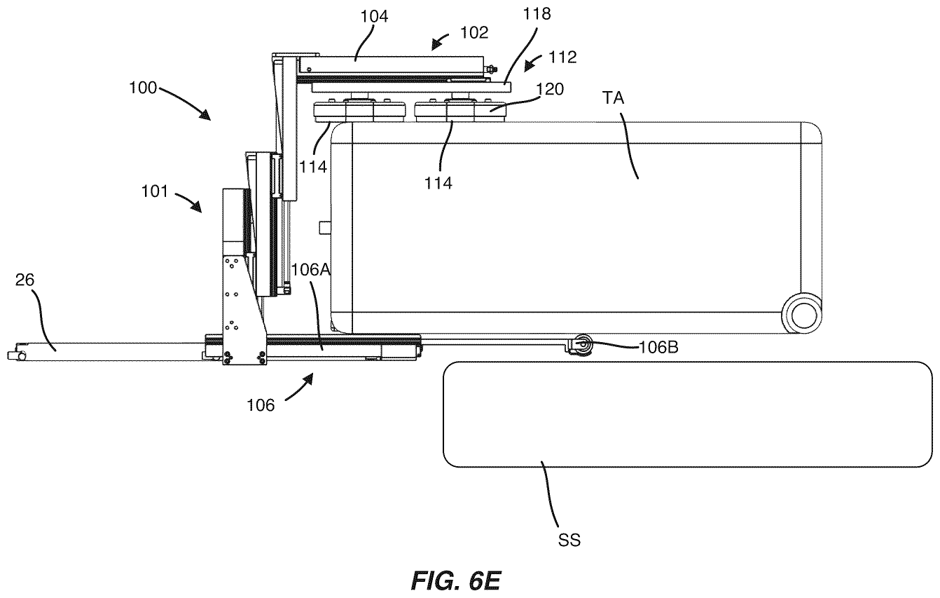

The end effector 100 can include a support bridge 101. The end effector 100 can further include an arm 102 that can extend away from the support bridge 101 in a first direction (e.g., the X direction shown in FIG. 2). The arm 102 can include a first support member 104. The end effector 100 can further include a support platform 106 extending away from the support bridge 101 in the first direction and at a position offset from the arm 102 to define a capture volume 108 disposed between the support platform 106 and the arm 102. The capture volume 108 can be configured to receive an article between the arm 102 and the support platform 106. The operation of obtaining an article by the end effector 110 and receiving the article in the capture volume 108 will be described in further detail with reference to FIGS. 6A-6E.

The end effector 100 can further include an article interface system 110 supported by the arm 102. As shown in FIG. 2, the article interface system 110 can include an actuatable article engagement device 112 operable to interface with a target article and to facilitate movement of the target article, such as to lift at least a portion of the target article, and/or to move the target article in a direction toward the support platform 106, and/or to facilitate movement of the target article relative to the support platform 106 to allow the support platform 106 to engage with the target article. The actuatable article engagement device 112 can include at least one article interface surface 114 that is configured to interface with the target article in order to move or manipulate the target article. Various configurations, structures, and alternative designs for each of the capture device, the article interface system, the actuatable article engagement device, and the arm will be described in further detail elsewhere in this disclosure.

With respect to the article interface system 110, the article interface system 110 can include a negative pressure source 116 in pneumatic communication with one or more suction ports 117. In one aspect, the negative pressure source 116 can be any pump, vacuum, or any other type of negative pressure source capable of directly generating a negative pressure. In another example, the negative pressure source can comprise a venturi vacuum system comprising one or more venturi vacuum devices in communication with a positive pressure generation device operable to introduce a motive fluid into the one or more venturi vacuum devices, the venturi vacuum system being operable to indirectly create a negative pressure area and to produce suction and fluid movement from one area to another. The type of negative pressure source 116 is not intended to be limited in any way by this application.

The actuatable article engagement device 112 can include a carriage 118. As shown in FIG. 2, the carriage 118 can be supported by and/or coupled to the arm 102, whether to the first support member 104 or to any other component of the arm 102. The suction ports 117 can be formed through the carriage 118. The actuatable article engagement device 112 can further include one or more suction assets 120 coupled to the carriage 118, the suction assets 120 being configured to be in pneumatic communication with the negative pressure source 116 (e.g., via the suction ports 117). The negative pressure source 116 can be operable to facilitate generation of a suction force at each of the one or more suction assets 120 by operation, or in other words by actuation, of the negative pressure source 116 to actuate the actuatable article engagement device 112. By operation of the negative pressure source 116, the suction assets 120 can be operable to apply a suction force to the target article (i.e., to suck to the target article) to secure the target article, or a portion thereof, to the article interface system 110 including the actuatable article engagement device 112, and to the arm 102, via the suction assets 120 and the suction force generated by the negative pressure source 116. In other words, the suction force produced at the suction assets 120 by the negative pressure source 116 can cause the target article to engage with the article interface system 110 and press against the article interface surface 114 (e.g., in this case, the surfaces or article contacting elements of the suction assets 120). The suction assets can be sized and configured to apply the suction force to the target article TA and to provide a seal, or at least a partial seal, about the target article TA, wherein the suction force is sufficient to secure the target article TA to the article interface system 110 and to the arm 102.

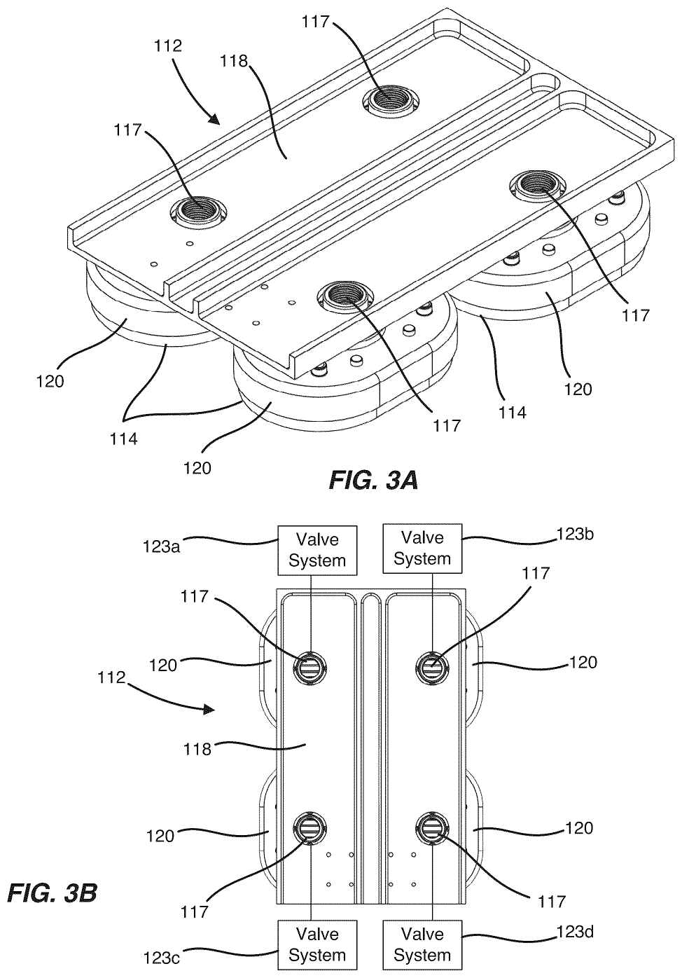

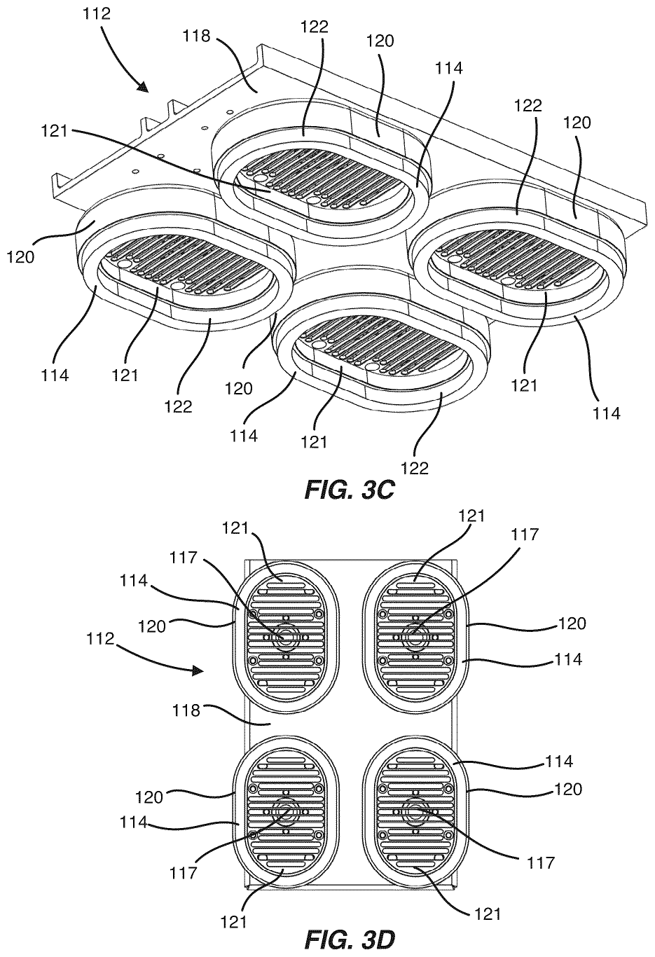

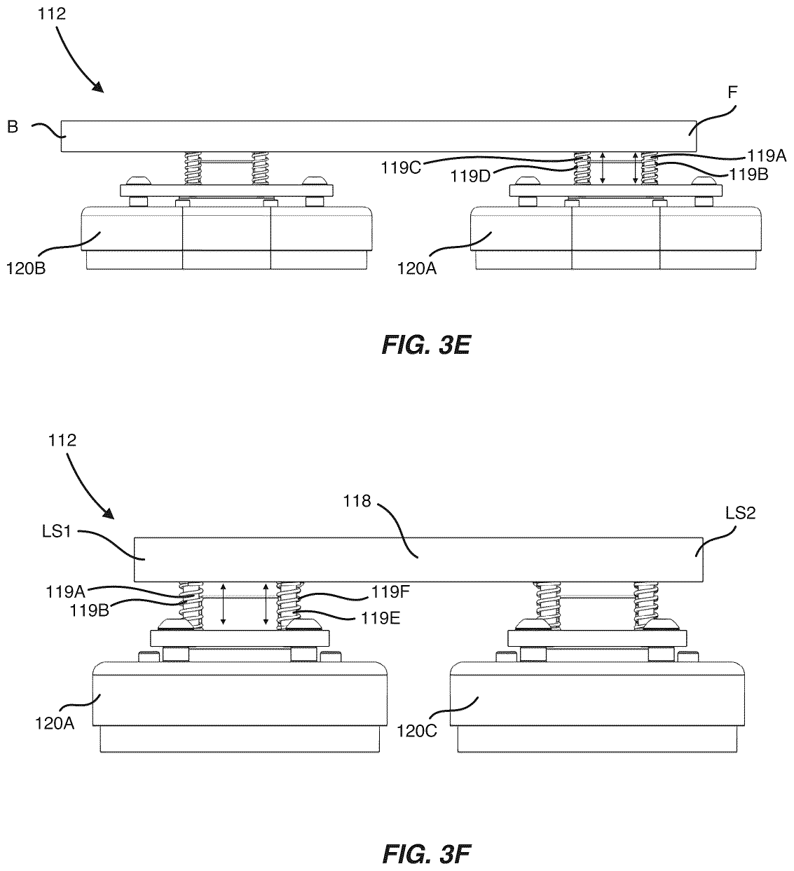

The suction assets 120 are shown in further detail in FIGS. 3A, 3B, 3C, and 3D, which illustrate the actuatable article engagement device 112 isolated from the rest of the end effector 100. As shown in FIGS. 3A-3D, a plurality of suction assets 120 can be coupled to the carriage 118. The number and configuration of suction assets 120 on the carriage 118 is not intended to be limited in any way by this disclosure. A plurality of suction assets 120 can be used, as shown in FIGS. 3A-3D, for redundancy to increase probability that at least one suction asset 120 interfaces with the target article and/or to distribute a suction force across different surface areas of the target article TA. However, it is to be understood that a single suction asset 120 can be used instead of the four suction assets 120 that are shown in the FIGS. 3A-3D. More than four suction assets 120 can also be used and is contemplated within the scope of this disclosure.

Each of the suction assets 120 can be in pneumatic communication with the negative pressure source 116 through a suction port 117 formed through the carriage 118, or disposed in a hole formed through the carriage 118. When the negative pressure source 116 is operable, the suction assets 120 act as vacuum nozzles with a suction force induced by the negative pressure source 116 being induced at each of the suction assets 120. The suction force can operate to cause the target article and the article interface device 110, namely the actuatable article engagement device 112 of the article interface device 110, to temporarily secure to each other via the suction assets 120 and the suction force provided by the negative pressure source 116, thereby facilitating lifting, movement, and manipulation of the target article by at least one of the article interface system 110 including the actuatable article engagement device 112, the arm 102, the support bridge 101, or any other component of the end effector 100. When the target article is engaged with the actuatable article engagement device 112, the article can be in contact with the lower surfaces of the suction assets 120 acting as the article interface surface. In one example, two or more of a plurality of suction assets 120 can be interconnected with one another, such as via a manifold, which manifold can be in communication with the negative pressure source 116. As such, each suction asset 120 can be operable with its own negative pressure source, or a single negative pressure source can be used to generate a negative pressure within a plurality of suction assets 120.

As shown in FIGS. 3C and 3D, each of the one or more suction assets 120 can be in the form of a cupped receptacle 121 that can be connected to be in pneumatic communication with the negative pressure source 116. Furthermore, each of the one or more suction assets 120 can comprise a compliant skirt 122 extending from an edge of the cupped receptacle 121. The compliant skirt 122 can be made of any compliant material without limitation (e.g., rubber, polymer, foam, elastomer, or any other compliant material) in order to facilitate engagement of the suction assets 120 with a surface of the target article.

As shown in FIGS. 3E and 3F, each of the one or more suction assets 120 can be moveably coupled to the carriage 118. FIG. 3E and 3F illustrate multiple suction assets 120 that can each be moveably coupled to the carriage 118. For convenience, only one of the suction assets (i.e., 120A) shown in FIGS. 3E and 3F will be described, however, it is to be understood that each of the suction assets (i.e., 120B and 120C) can be moveably coupled to the carriage 118 in a similar manner to suction asset 120A. FIG. 3E shows a side view of the carriage 118 and the suction asset 120A and FIG. 3F illustrates a front view of the carriage 118 and the suction asset 1220A. The suction asset 120A can be moveably coupled to the carriage 118 via a plurality of pins 119A, 119C, and 119E. The suction asset 120A can be configured to slide along each of the plurality of pins 119A, 119C, and 119E in a linear direction towards and away from the carriage 118. It is to be understood that the suction asset 120A can slide independently on each of the pins 119A, 119C, and 119E.

For example, the suction asset 120A can slide further on the pin 119A toward the carriage 118 than on the pin 119C to cause the suction asset 120A to tilt with respect to the carriage 118 in a front-back tilting configuration with respect to a front F and back B of the carriage 118 as shown in FIG. 3E. Alternatively or additionally, the suction asset 120A can slide further on the pin 119A toward the carriage 118 than on the pin 119E to cause the suction asset 120A to tilt with respect to the carriage 118 in a side-to-side tilting configuration with respect to lateral sides LS1 and LS2 of the carriage 118 as shown in FIG. 3F. In short, the suction asset 120A can slide further on any of the pins (e.g., 119A, 119C, and 119E) toward the carriage 118 than on any other of the pins (e.g., 119A, 119C, and 119E) to cause the suction asset 120A to tilt in order to facilitate engagement of the suction assets 120 with a surface of the target article in which the target article is tilted with respect to the carriage 118. A biasing member 119B, 119D, and 119F can be respectively associated with the pins 119A, 119C, and 119E. The biasing members 119B, 119D, and 119F can be operable to bias the suction asset 120A away from the carriage 118 and can be operable to compress under an applied force to align the suction asset 120A with a surface of the target article TA. It is to be understood that the biasing members can be any structure or member (e.g., a spring) operable to bias another structure without any intended limitation. Additionally, the suction asset 120A can include any number of pins and/or biasing members without limitation.

The article interface system 110 can further comprise a valve or valve system associated with the actuatable article engagement device 112, and particularly each of the suction assets 120. As shown in FIG. 3B, each of the suction assets 120 can be associated with a valve system (see valve systems 123a, 123b, 123c, and 123d, each associated with a respective suction asset). The valve system(s) can comprise a valve and sensor. In one example, the each of the valve systems 123a-d can comprise an internal flow-based shut-off valve that operates to shut off or reduce the flow of air to the suction asset with which the valve system is associated in the event that that particular suction asset is not able to provide and maintain a pre-determined threshold suction force to be applied to the target article as sensed by the sensor. By shutting off or reducing the air flow to one or more underperforming suction assets, the suction force in the remaining suction assets can be preserved or even increased. The threshold suction force can be set at any needed or desired level. The valve system operable with a given suction asset can be actuated at select times to turn on and off the flow of air through the suction asset. Additionally, the valve systems 123a-d can further include a vent valve operable to open in order to expose an interior of one or more suction assets 120 to either vent gas within the suction asset to the atmosphere or to allow gas from the external environment to enter the one or more suction assets 120 to equalize pressure within the one or more suction assets 120 with the external environment.

Various combinations and configurations of the arm 102, the support platform 106, and the support bridge 101 will now be described with returning reference to FIG. 2. As shown in FIG. 2, the support bridge 101 can comprise a first lift member 101A, a second lift member 101B, and a third lift member 101C. The first lift member 101A can be moveable relative to the second lift member 101B and the third lift member 101C. The second lift member 101B can be moveable relative to the first lift member 101A and the third lift member 101C. As shown, the third lift member 101C can be fixed relative to the support platform 106 and the first and second lift members 101A and 101B can be moveable relative to the third lift member 101C. Although three lift members are illustrated in FIG. 2 (first lift member 101A, second lift member 101B, and third lift member 101C), it is to be understood that only two lift members may be used to make the support bridge extendable. Additionally, more lift members than three can be used to provide further extension to the support bridge 101.

With respect to the support bridge 101, the first lift member 101A can be made to translate with respect to the second lift member 101B. As illustrated, the first lift member 101A and the second lift member 101B of the support bridge 101 can be configured as slideable plates with the first lift member 101A being slidably coupled to the second lift member 101B with rails that facilitate sliding motion between the first lift member 101A and the second lift member 101B of the support bridge 101. Similarly, the second lift member 101B and the third lift member 101B of the support bridge 101 can be configured as slideable plates with the second lift member 101B being slidably coupled to the third lift member 101C with rails that facilitate sliding motion between the second lift member 101B and the third lift member 101C.

However, the first lift member 101A can be moveably coupled to a second lift member 101B in any way in which the first lift member 101A is actuatable to move in a linear direction along an axis of the support bridge 101 relative to the second lift member 101B without any intended limitation. In other words, the first lift member 101A is moveably coupled to the second lift member 101B and is actuatable to move in a linear direction along an axis (longitudinal axis) of the support bridge 101 either in a telescoping fashion, sliding fashion, or in any other way in which linear translation of a support bridge 101 can be achieved. The one or more lift members (e.g., 101A, 101B, and 101C) of the support bridge 101 can be configured to be connected via one or more types of joints that facilitate movement in any manner of one or more lift members relative to any other lift members in any type of degree of freedom, such as linearly, rotationally, or in any combination of these.

To achieve translation of the first lift member 101A and the second lift member 101B relative to one another, the first and second lift members 101A and 101B can be coupled together at an actuatable joint 124. An actuator 125, whether being a linear, rotational, or other type of actuator, associated with the actuatable joint 124 can be operable to impart translational motion between the second lift member 101B and the first lift member 101A to move these relative to one another in at least one degree of freedom (such as a linear degree of freedom, or in other words, a translating degree of freedom). In other words, depending upon the configuration of the support bridge 101, the actuator 125 can move at least one of the first lift member 101A or the second lift member 101B to achieve relative translational motion between the first and second lift members 101A and 101B. In the example shown, the actuator 125 can comprise a linear or a rotational actuator operable to extend and retract the first lift member 101A relative to the second lift member 101B. As will be understood by FIG. 2, extending or retracting the support bridge 101 in a linear degree of freedom (e.g., in a Y direction) will move the support platform 106 and the arm 102 farther apart or closer together to expand or contract the capture volume 108 to fit the size of an article being acquired by the end effector 100.

To achieve translation of the second lift member 101B and the third lift member 101C relative to one another, the second and third lift members 101B and 101C can be coupled together at an actuatable joint 126. An actuator 127, whether being a linear, rotational, or other type of actuator, associated with the actuatable joint 126 can be operable to impart translational motion between the second lift member 101B and the third lift member 101C to move these relative to one another in at least one degree of freedom (such as a linear degree of freedom, or in other words, a translating degree of freedom). In other words, depending upon the configuration of the support bridge 101, the actuator 127 can move at least one of the second lift member 101B or the third lift member 101C to achieve relative translational motion between the third and second lift members 101C and 101B. In the example shown, the actuator 127 can comprise a linear or a rotational actuator operable to extend and retract the second lift member 101B relative to the third lift member 101C. Although the support bridge 101 is shown with two actuators 125 and 127, it will be understood that a single actuator can be used to provide the linear motion of each of the first and second lift members 101A and 101B. The arm 102 of the end effector 100 can be configured as a fixed arm coupled to the support bridge 101 such that the arm 102 does not move relative to the support bridge 101 and the carriage 118 is fixed relative to the first support member 104. However, alternatively, the carriage 118 of the actuatable article engagement device 112 coupled to the first support member 104, is moveable relative to the first support member 104 (e.g., via sliding along rails of the first support member 104).

With respect to the extendable configuration of the arm 102, the arm 102 can comprise a first support member 104 coupled to the support bridge 101. It is to be understood that the first support member 104 can alternatively be coupled to the support bridge by one or more other support members and the first support member 104 can be moveably coupled to one of the other support members to facilitate movement of the first support member 104 relative to the other support member and the support bridge 101.

In the example shown in FIG. 2, the first support member 104 and the carriage 118 can be moveable relative to one another. For example, the carriage 118 can be made to translate with respect to the first support member 104. As illustrated, the carriage 118 and the first support member 104 of the arm 102 can be coupled in a sliding configuration such that the carriage 118 is slide relative to the first support member 104 along rails of the first support member 104. However, the carriage 118 can be moveably coupled to a first support member 104 in any way in which the carriage 118 is actuatable to move (e.g., in a linear direction along an axis of the arm 102) relative to the first support member 104 without any intended limitation. In other words, the carriage 118 is moveably coupled to the first support member 104 and is actuatable to move in a linear direction along an axis (longitudinal axis) of the arm 102 either in a sliding fashion, a telescoping fashion, or in any other way in which linear translation of a support member can be achieved. The arm 102 can be configured in many different ways other than as shown in FIGS. 2 and 3. For example, the arm can be configured to comprise one or more links or support members connected via one or more types of joints that facilitate movement in any manner of one or more links/support members relative to any other links/support members in any type of degree of freedom, such as linearly, rotationally, or in any combination of these.

To achieve movement (e.g., translational movement, rotational movement, or both) of the carriage 118 and the first support member 104 of the arm 102 relative to one another, the carriage 118 and the first support member 104 can be coupled together at an actuatable joint 105. An actuator 107, whether being a linear, rotational, or other type of actuator, associated with the actuatable joint 105 can be operable to impart motion (e.g., translational motion) between the carriage 118 and the first support member 104 to move these relative to one another in at least one degree of freedom (such as a linear degree of freedom, or in other words, a translating degree of freedom). In other words, depending upon the configuration of the arm 102, the actuator 107 can move at least one of the carriage 118 or the first support member 104 to achieve relative translational motion between the carriage 118 and the first support member 104. In the example shown, the actuator 107 can comprise a linear or a rotational actuator operable to extend and retract the carriage 118 relative to the first support member 104. In one example, the actuator 107 can be configured or controlled to comprise a vibration or oscillation mode in which the actuator 107 can be operated in a manner so as to vibrate or rapidly oscillate the carriage 118 and/or the first support member 104 of the arm 102, as well as to effectuate the extension and retraction of the carriage 118 and the first support member 104 relative to one another.

With reference to the support platform 106, the support platform 106 can include a stationary member 106A coupled to the support bridge 101 and an extensible member 106B moveably coupled to the stationary member 106A and operable to extend and retract relative to the stationary member 106A. The support platform 106 can extend away from the support bridge 101 in a direction substantially the same as the arm 102, as shown in FIG. 2. The support platform 106 can further comprise an actuatable joint 128 operable to facilitate movement of the extensible member 106B relative to the stationary member 106A (e.g., in a linear or translational degree of freedom) to facilitate insertion of the extensible member 106B between a target article and a surface in support of the target article. With the arm 102 and the support platform 106 both being coupled to the support bridge 101, extending in a same direction, and at offset locations from each other, the support bridge 101, the arm 102, and the support platform 106 can together define the capture volume 108 configured to receive an article between the arm 102 and the support platform 106.

In the example shown in FIG. 2, the extensible member 106B and the stationary member 106A of the support platform 106 can be moveable relative to one another. For example, the extensible member 106B can be made to translate with respect to the stationary member 106A. As illustrated, the extensible member 106B and the stationary member 106A of the support platform 106 can be configured as telescoping support members with the extensible member 106B being configured to slide in and out of the stationary member 106A in a telescoping fashion. However, the extensible member 106B can be moveably coupled to a stationary member 106A in any way in which the extensible member 106B is actuatable to move (e.g., in a linear or translational direction) along an axis of the support platform 106 relative to the stationary member 106A without any intended limitation. In other words, the extensible member 106B is moveably coupled to the stationary member 106A and is actuatable to move in a linear direction along an axis (longitudinal axis) of the support platform 106 either in a sliding fashion, a telescoping fashion, or in any other way in which translation of a support member can be achieved. The support platform 106 can be configured in many different ways other than as shown in FIG. 2. For example, the support platform can be configured to comprise one or more links or support members connected via one or more types of joints that facilitate movement in any manner of one or more links/support members relative to any other links/support members in any type of degree of freedom, such as linearly, rotationally, or in any combination of these.

To achieve translation of the extensible member 106B and the stationary member 106A relative to one another, the extensible member 106B and the stationary member 106A can be coupled together at an actuatable joint 128. An actuator 129, whether being a linear, rotational, or other type of actuator, associated with the actuatable joint 128 can be operable to impart translational motion between the extensible member 106B and the stationary member 106A to move these relative to one another in at least one degree of freedom (such as a linear degree of freedom, or in other words, a translating degree of freedom). In other words, depending upon the configuration of the support platform 106 the actuator 129 can move at least one of the extensible member 106B or the stationary member 106A to achieve relative translational motion between the extensible member 106B and the stationary member 106A. In the example shown, the actuator 129 can comprise a linear or a rotational actuator operable to extend and retract the extensible member 106B relative to the stationary member 106A. In one example, the actuator 129 can be configured or controlled to comprise a vibration or oscillation mode in which the actuator 129 can be operated in a manner so as to vibrate or rapidly oscillate the support platform, and particularly the extensible member 106B and/or the stationary member 106A, as well as to effectuate the extension and retraction of the stationary member 106A and the extensible member 106B relative to one another.

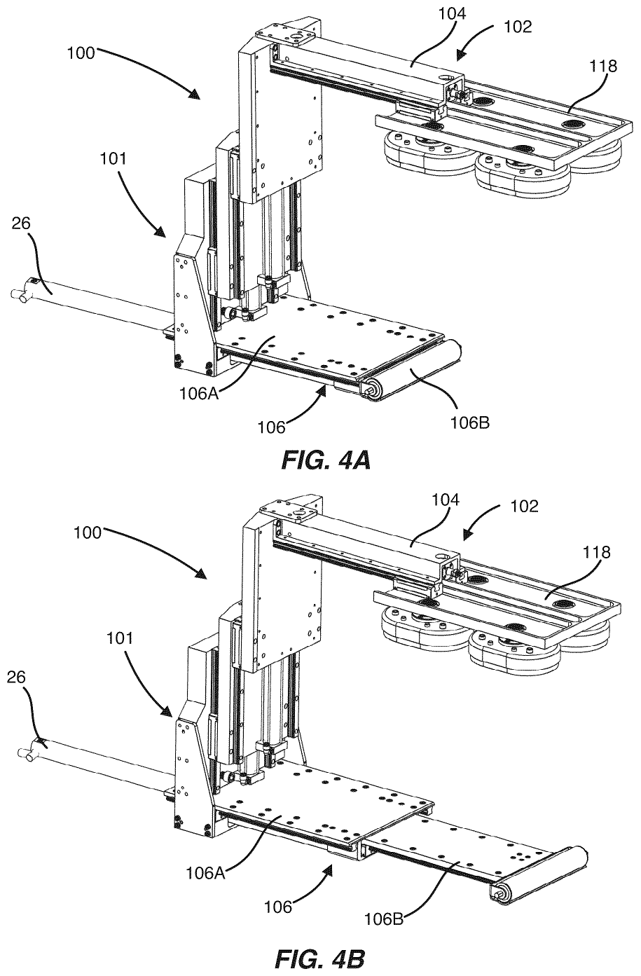

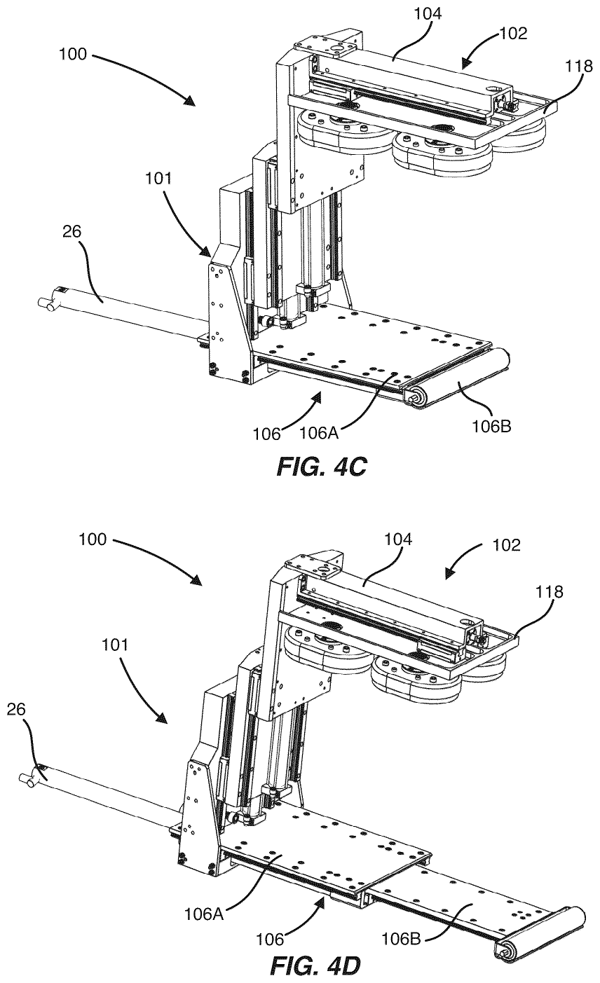

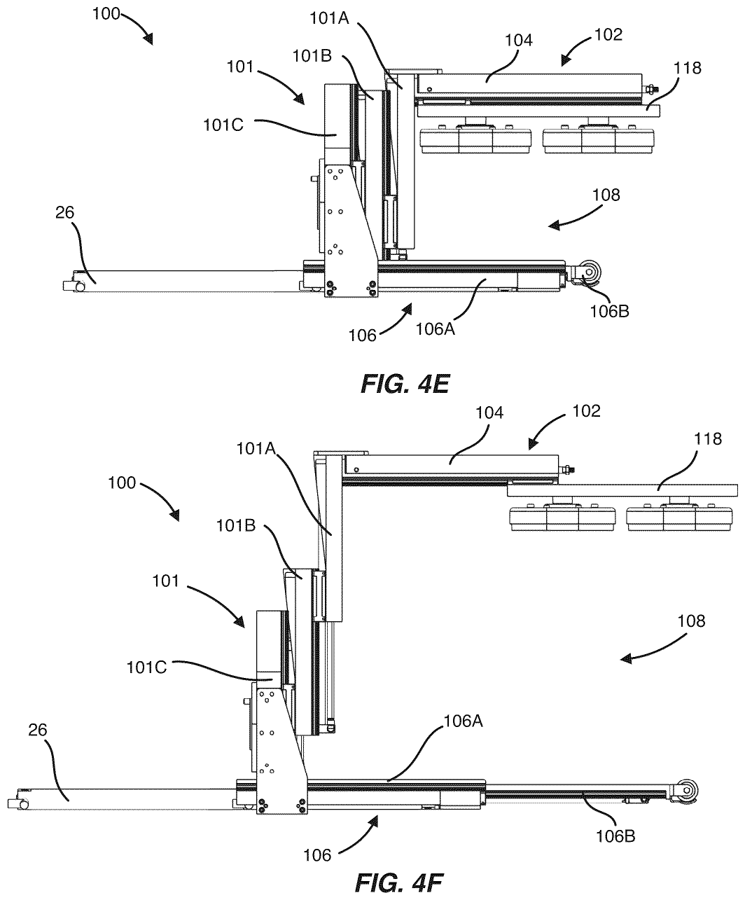

With each of the support bridge 101, the arm 102, and the support platform being extendable via actuation of one or more actuators, it will be understood that a plurality of states, positions, and configurations of elements of the end effector 100 are possible. Various such states are illustrated in FIGS. 4A-4F. For example, it will be understood from FIG. 2 that, depending on a state of the carriage 118 (i.e., whether extended or retracted relative to the first support member 104), the extensible member 106B in the extended position can be positioned under the carriage 118 or under empty space at a distal end of the carriage 118 distal to the support bridge 101. As an example of extension and retraction of the support platform 106, FIG. 4A illustrates the end effector 100 including the support bridge 101, the arm 102, and the support platform 106, where the extensible member 106B of the support platform 106 is retracted relative to the stationary member 106A. FIG. 4B illustrates the end effector 100 including the support bridge 101, the arm 102, and the support platform 106, where the extensible member 106B of the support platform 106 is extended relative to the stationary member 106A.

It will be further understood from FIG. 2 that translating the carriage 118 relative to the first support member 104 can cause the carriage 118 to be positioned over the stationary member 106A of the support platform 106 or to extend past the stationary member 106A of the support platform. Depending on the state of the extensible member 106B (i.e., whether extended or retracted relative to the stationary member 106A), the carriage 118 can be disposed over the extensible member 106A or over empty space at a distal end of the support platform 106 distal to the support bridge 101. As an example of extension and retraction of the arm 102, FIGS. 4A and 4B illustrate the end effector 100 in a state where the carriage 118 is extended relative to the first support member 104. FIGS. 4C and 4D illustrate the end effector 100 in a state in which the carriage 118 is retracted relative to the first support member 104. The extensible member 106B of the support platform 106 is extended in FIG. 4D and retracted in FIG. 4C.

It will be further understood from FIG. 2 that the support bridge 101 can be collapsed and expanded to a plurality of positions. Translating one or more of the first, second, and third lift members 101A, 101B, and 101C of the support bridge 101 relative to the other lift members can cause the capture volume 108 to adjust size and to allow for the capture of different sized articles. For example, FIG. 4E illustrates the end effector 100 in a state where the lift members 101A, 101B, and 101C of the support bridge 101 are retracted such that the support bridge 101 is in a collapsed position. The arm 102 and the support platform 106 are also shown in retracted positions, however, it is to be understood that any combination of extension/retraction of the arm 102 and the support platform 106 can be achieved while the support bridge 101 is collapsed as shown in FIG. 4E. FIG. 4F illustrates the end effector 100 in a state where the lift members 101A, 101B, and 101C of the support bridge 101 are extended such that the support bridge 101 is in an extended position. The arm 102 and the support platform 106 are also shown in extended positions, however, it is to be understood that any combination of extension/retraction of the arm 102 and the support platform 106 can be achieved while the support bridge 101 is extended as shown in FIG. 4F.

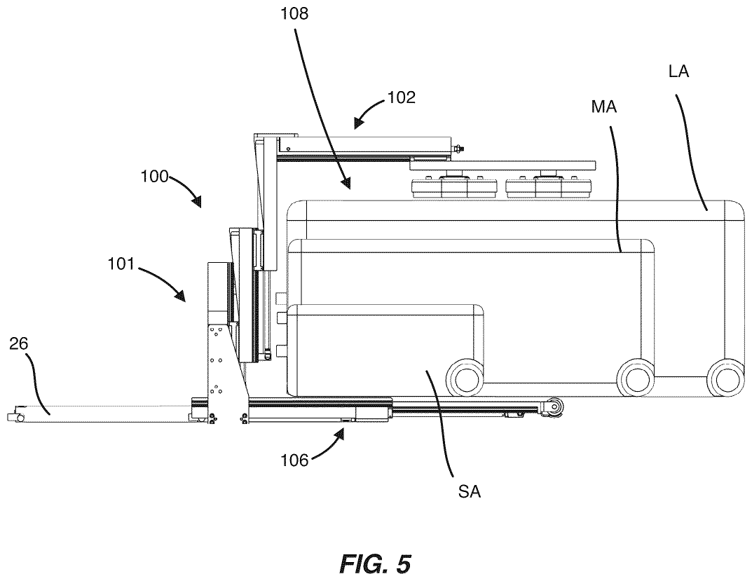

The extendibility of the support bridge 101, the support platform 106, and the arm 102 as illustrated in FIGS. 4A-4F allows for the end effector 100 to acquire articles of different shapes and sizes. FIG. 5 illustrates various sizes of articles compared to the end effector 100. For example, the capture volume 108 is adjustable by extension or retraction of one or more of the support bridge 101, the arm 102, and/or the support platform 106 in order to accommodate any of a large article LA, a medium article MA, a small article SA, or any other article in between the large, medium, and small articles.

With returning reference to FIG. 2, additional elements can optionally be included on the end effector 100. For example, the end effector 100 can further include a load sensor 130 associated with at least one of the support platform 106, the support bridge 101, and/or the arm 102. The load sensor 130 can be operable to derive an engagement force acting between the article and the support platform 106. It should be understood that the load sensor 130 is shown schematically in FIG. 2 as being associated with the end effector 100 and that the load sensor 130 can be placed anywhere on the support platform 106 that is suitable for measuring an engagement force acting between the article and the support platform 106. The operation of the load sensor 130 will be described in further detail elsewhere in this disclosure.

The end effector 100 can further optionally include an interface sensor 132 to determine the suction force at the suction assets 120, or to determine a load exerted by the article on the suction assets 120 or the carriage 118 to determine a state of acquisition of the article with the article interface system 110 or the actuatable article engagement device 112. The operation of the interface sensor 132 will be described in further detail elsewhere in this disclosure. It should be understood that the interface sensor 132 is shown schematically in FIG. 2 as being associated with the end effector 100 and that the interface sensor 132 can be placed anywhere on the carriage 118, suction assets 120, or any other part of the actuatable article engagement device 112 that is suitable for measuring an engagement force acting between the article and the actuatable article engagement device 112. The operation of the interface sensor 132 will be described in further detail elsewhere in this disclosure.

As further shown in FIG. 2, and in conjunction with FIG. 1, one or more sensors 6 can be placed or associated with any of the components of the end effector 100 including the support bridge 101, the arm 102, the first support member 104, the support platform 106 (e.g., either or both of the stationary member 106A and the extensible member 106B, the article interface system 110, the actuatable article engagement device 112, the carriage 118, the suction assets 120, or any other components of the end effector 100 suitable to support a sensor thereon. The sensors 6 can be one or more sensors such as global positioning sensors (GPS), optical cameras, infra-red (IR) cameras or sensors, LIDAR sensors, pressure sensors, force sensors, inertial measurement unit sensors, rangefinders, and others, and any combination of these. The system controller 4 can include some or all of these types of sensors 6. In some examples, some or all of the sensors 6 are embedded into each of the platform 28, the robotic positioning member 25, and the robotic end effector 100 with the system controller 4 being able to communicate with each of these and receive data therefrom in order to facilitate autonomous movement and operation of all or each individual component of the end effector 100.

The end effector 100 can further optionally include a vibrational actuator 134 operably supported on at least one of the arm 102, the support bridge 101, the support platform 106, including either the extensible member 106B and/or the stationary member 106A of the support platform 106. The vibrational actuator 134 can be operable to vibrate whatever structural member or members with which it is associated at select times as needed or desired. For example, the vibrational actuator 134 can be associated with the support platform, and particularly the extensible member 106B, wherein the vibrational actuator 134 can be actuated during extension of the extensible member 106B relative to the stationary member 106A of the support platform 106 to facilitate insertion of the extensible member 106B between the target article and the surface in support of the target article. The vibrational actuator 134 is shown schematically in FIG. 2, but can be placed anywhere on the end effector 100 suitable to impart a vibration on the extensible member 106B. The operation of the vibrational actuator 134 will be described in further detail elsewhere in this disclosure.

The acquisition of an example target article TA by the end effector 100 will be described with reference to FIGS. 1-6E. The example illustrated in the figures is a non-limiting of the end effector 100 being used to acquire articles that are commonly loaded on to a transport or vehicle (e.g., airplane, train, bus, ship/boat) for humans or that are cargo. In this example method or process for acquiring an article or articles, such as a bag or baggage, the end effector 100 can be used to acquire small, medium, large, or other sized articles in the capture volume 108. The size of the capture volume 108 is not intended to be particularly limited by this disclosure in any way. The size of the capture volume 108 can be established based on context and application. For example, in an airline baggage handling context, the capture volume can be sized at about 25″ wide x 18″ high, so that an article the size of a commonly-used luggage bag checked on an airline can be received in the capture volume 108 with room for clearance between the and the support bridge 101, the arm 102, and the support platform 106 defining the capture volume 108.

Various method steps can be carried out to obtain the target article TA. The target article TA can be alone or can be stacked or surrounded on multiple sides by one or more other articles BA to be later acquired, as shown in FIG. 6A. The articles BA can also be a support surface on which the target article TA is resting and need not be limited to another bag, suitcase, luggage, or other article. The articles (e.g., TA and BA) can be stacked on the ground, on a trailer, on a flat-bed, on a utility vehicle, on a floor (e.g., warehouse, shipping or loading dock, store, etc.), on a rack, on a shelf, or on any other surface capable of supporting the articles TA and BA without limitation. The article BA may also not be an article but can instead be a surface of the trailer, on a flat-bed, on a utility vehicle, on a floor (e.g., warehouse, shipping or loading dock, store, etc.), on a rack, on a shelf, or on any other surface capable of supporting the target article TA. The articles, in other words, are at a first location and are awaiting acquisition and management, such as movement from one location to another location. For example, it may be the intent to acquire and move the articles from the first location and load these onto a vehicle or conveyor. Or, it may be that the articles need to be unloaded from a vehicle or other first location. Those skilled in the art will recognize that the type and condition of the first location where the article or articles currently reside ready to be acquired by the end effector 100 and the second location where the article is to be moved to and released is not intended to be limiting in any way.

In a first step of acquisition, the end effector 100 can be initially separated from or located away from the target article TA to be acquired (i.e., the end effector 100 is positioned in an initial position away from the target article TA such that the end effector cannot interact with the target article). From the initial position, the end effector 100 can be moved into a position in which the end effector 100 is in operational proximity to the target article TA, as shown in FIG. 6A (the term “operational proximity” meaning that the end effector 100 is brought to a position, via macro positioning movements by the platform 28 or the robotic positioning member 25 to which the end effector 100 is coupled, where the end effector 100 is capable of acting on the subject article to be acquired (the target article TA) by micro positioning and actuation/operation movements of one or more components of the end effector 100). For example, the end effector 100 can be moved from the initial position into operational proximity to the target article by manipulating the robotic positioning member 25 (e.g., a robotic arm) toward the target article TA, such that the end effector 100 is brought into operational proximity with the target article TA. Additionally or alternatively, the robotic positioning member 25 can be attached to a mobile platform (e.g., a utility vehicle) that is able to be operated at least one of autonomously or actively by a user to move the robotic positioning member 25 and end effector 100 at least partially into proximity to the target article TA, which proximal location may comprise operational proximity, or where the robotic positioning member 25 may further be required to bring the end effector 100 into operational proximity to the article(s) in the event the mobile platform is unable achieve this level of proximity. One or more sensor(s) 6 can be used, in conjunction with the system controller 4 of FIG. 1, to facilitate autonomous movement and alignment of the platform 28 and the end effector 100 into operational proximity with the target article TA. For example, GPS, cameras, LIDAR sensors, or other visual sensors can be used to sense a position of the article through edge identification, surface identification, or other feature identification to initially position the platform 28 and the end effector 100 in operational proximity to the target article TA.

Additionally or alternatively, the actuatable article engagement device 112 that is moveably coupled to the first support member 104 at an actuatable joint 105 can be actuated by actuator 107 to move relative to the first support member 104, in order to move the actuatable article engagement device 112 from a first position away from the target article TA (see FIGS. 4A and 4C) to a second position over the target article (see FIG. 6A) in which the suction assets 120 are positioned adjacent (i.e., in contact with or just out of contact with, but close enough to apply a suction force) the target article TA so that the target article TA can be caused to temporarily secure to the article interface system 110 via the suction assets 120 and the applied suction force SF. As indicated herein, the platform 28 method or system used to move and/or facilitate the end effector 100 being brought into proximity with the target article TA is not intended to be limited by this disclosure in any way. One or more sensor(s) 6, in conjunction with the system controller 4 of FIG. 1, can be used to facilitate movement and alignment of the article interface system 110 and the actuatable article engagement device 112 into operational proximity with the target article TA. For example, GPS, cameras, LIDAR sensors, or other visual sensors can be used to sense a position of the article through edge identification, surface identification, or other feature identification of the target article TA or its surroundings to align and position the article interface system 110 and the actuatable article engagement device in operational proximity to the target article TA.

When in the position shown in FIG. 6A, the end effector 100 can be operated to cause the actuatable article engagement device 112 to move from the initial position to a first position such that the article interface surface 114 to engage with the target article TA. For example, the entire end effector 100 and/or the robotic positioning member 25 (e.g., robotic arm) to which the end effector 100 is attached can be moved in any direction into a position where the article interface surface 114 is caused to come into contact with the target article TA. Alternatively, or additionally, the arm 102 can be extended (e.g., the carriage 118 can be extended relative to the first support member 104 in a translational degree of freedom by actuating actuatable joint 105 via actuator 107) until the article interface surface 114 is caused to be in contact with the target article TA or in close proximity to the target article TA.

Additionally, or alternatively, the article interface system 110 supported by the arm 102 can be operated to move the actuatable article engagement device 112 with its article interface surface 114 into contact with the target article TA to interface with the target article TA and to facilitate movement of the target article TA, such as to lift at least a portion of the target article, and/or to move the target article in a direction towards or further onto the support platform. The actuatable article engagement device 112 can, for example, be moved into contact with the target article TA by extending or retracting the support bridge 101 (via actuation of one or more actuators 125 and 127 to move one or more of the lift members 101A and 101B relative to other lift members 101A, 101B, and 101C about joints 124 and 126) in order for the carriage 118 and arm 102 to be brought into contact with the target article TA. It is also contemplated that the carriage can be actuatable relative to the first support member 104 in a direction toward and away from the support platform 106 such that the carriage can be brought into contact with the target article TA without movement of the support bridge 101.

For example, the article interface system 110 can facilitate movement of the target article TA by first moving the actuatable article engagement device 112 from an initial position (e.g., shown in FIG. 6A) out of contact with the target article TA to a first position (e.g., shown in FIG. 6B) relative to the target article TA in which the actuatable article engagement device 112 with its article interface surface 114 engages with the target article TA. Additionally, or alternatively, the negative pressure source 116 in pneumatic communication with the suction assets 120 can be operated to generate the suction force SF at each of the suction assets 120. The suction force SF can be strong enough to secure, at least in part, the target article TA so that the robotic end effector 1000 can manipulate and move the target article TA, such as to at least partially lift the target article TA off of the article BA and into contact with article interface surfaces 114 on the suction assets 120, whereby the target article TA can be secured to the article interface device 110 and the arm 102. With a strong enough suction force SF, the actuators or actuatable joints of the end effector 100 may not need be operated in order to bring the target article into contact with the interface surfaces 114, although these certainly can be utilized where needed or desired to assist in manipulating the target article TA once secured via the applied suction force.

As recited elsewhere in this disclosure, an interface sensor 132 can be included on the actuatable article engagement device 112 in order to determine if the target article TA is adequately held and secured by the actuatable article engagement device 112. The interface sensor 132 can be a sensor (e.g., such as sensor 30) that is operable to measure a suction force, a load, or to identify proximity of the target article TA optically or visually in order to determine when the actuatable article engagement device 112 has sufficient hold on the target article TA. Any type of sensor operable to detect interaction between an actuatable article engagement device 112 and a target article TA is intended to be within the scope of interface sensor 132 without any intended limitation. The interface sensor 132 can, for example, measure an interaction force, suction force, load or other force between the target article TA and the actuatable article engagement device 112 (e.g., at the suction assets 120) operably supported on at least one of the arm, one or more of the suction assets, or the carriage, to determine a state of suction, acquisition, or interaction between the target article TA and the suction assets (i.e., the actuatable article engagement device 112). The measured force can be compared to a predetermined engagement threshold value indicating acquisition of the target article by the suction assets (e.g., the actuatable article engagement device 112). If the measured force is greater than or equal to the predetermined engagement threshold value, the computing device 32 can determine that the target article TA is in sufficient contact with or being sufficiently held by the actuatable article engagement device 112.

During or following engagement between the article interface surface 114 and the target article TA, the target article TA can be at least partially lifted off of the other article BA in order to expose a gap G between the target article TA and the other article BA. For example, the gap G can be formed by operating the negative pressure source 116 to secure the target article TA to the article interface system 110 and the arm 102 via the suction assets 120 of the actuatable article engagement device 112 of the article interface system 110 and the applied suction force SF. The act of securing the target article TA by applying the suction force may function to separate at least a portion of the target article TA (e.g., the front edge) from the surface in support of the target article TA (e.g., article BA) to provide the gap G between the target article TA and the surface (e.g., article BA) into which the extensible member 106B can be inserted. In some cases, once the target article TA is secured to the article interface system 100 and the arm 102 via the applied suction force, one or more actuators within the robotic end effector 100 (e.g., those used to raise/lower the arm 102, to actuate the article interface system 110, or others) may also need to be actuated to lift at least a portion of the target article TA (e.g., its front edge) from its supporting surface, such as article BA, to form the gap G.

As shown in FIG. 6B, the entire target article TA can be lifted off of the other article BA. However, the target article TA can be determined to be sufficiently held and can open a sufficient gap G even in a case where only one end of the target article TA is lifted off of the other article BA. In other words, the gap G need not be a complete separation between the target article TA and the other article BA. For example, the article interface system 110 and the actuatable article engagement device 112 can be operated to lift a portion of the target article, such as that portion of the target article closest in proximity to the robotic end effector 100 (e.g., a front or first edge of the target article in the view shown in FIG. 6A), wherein the target article is partially lifted and partially supported by the article BA, such that the target article is on an incline, and the gap G comprises an opening below the lifted first or front edge portion of the target article, the gap G converging toward a close near the opposite second or rear edge or portion of the target article still resting on the article BA.

With the gap G at least partially open and created between the target article TA and the other article BA, the support platform can be extended to enter into the gap G between the target article TA and the other article BA, as shown in FIG. 6C. The support platform 106 can be extended by extending the extensible member 106B relative to the stationary member 106A. The extensible member 106B can be extended (e.g., in a linear or translational degree of freedom) relative to a stationary member 106A of the support platform 106 by actuation of an actuatable joint 128 operable to move the extensible member 106B relative to the stationary member 106A. The extensible member 106B can be inserted between the target article TA and a surface (e.g., BA) in support of the target article TA to transition the target article TA from being supported by the surface (e.g., BA) to being supported by the extensible member 106B.

The gap G may be large enough to fit the extensible member 106B between the target article TA and the other article BA without the extensible member 106B contacting one or both of the target article TA and the other article BA, as shown in FIG. 6C. However, it is to be understood that the extensible member 106B may be in contact with either or both of the target article TA and other article BA as it is inserted into the gap G. In other words, the actuator 129 can be powerful enough to insert the extensible member 106B into the gap G even with some resistance from the target article TA or the other article BA. The extensible member 106B can operate to separate the target article TA and the other article BA from each other as the extensible member 106B is extended into the gap G.

One or more sensor(s) 6, as shown in FIGS. 1 and 2, can be used, in conjunction with the system controller 4 of FIG. 1, to facilitate movement and alignment of the extensible member 106B into the gap G between the target article TA and the other article BA. For example, cameras, LIDAR sensors, or other visual sensors can be used to sense a position of the article through edge identification, surface identification, or other feature identification of the target article TA or its surroundings. Visual sensors can further be used in conjunction with the controller 4 to determine a size of the gap G and to determine if the gap G is large enough to allow for the extensible member 106B to be inserted into the gap G to retrieve the target article TA. The sensor(s) 6 can further be used to align and position the support platform 106 and the extensible member 106B with the gap G. The sensor(s) 6 can further include or be a load sensor operable to detect a force caused by resistance as the extensible member 106B is inserted into the gap G. Resistance of a certain level on the extensible member 106B as the extensible member 106B is inserted into the gap G may indicate that the target article TA was not adequately lifted or that adjustments should be made before inserting the extensible member 106B into the gap G. The sensor(s) 6 can similarly be used to determine that the extensible member 106B is successfully inserted into the gap G.

Further sensors, as described elsewhere in this disclosure, can be used to determine when to extend the extensible member 106B, when to actuate the actuatble article engagement device 112, when to move elements of the arm 102, the support platform 106, and the support bridge 101, and to determine a state of acquisition of the target article. Thereby, the sensor(s) 6, and any other sensors described herein, can be used individually or in combination with each other to facilitate full or at least partial autonomous operation of the end effector 100 when acquiring a target article TA.

As recited elsewhere in this disclosure, an interface sensor 132 can be associated with the article interface system 110, the actuatable article engagement device, the suction assets 120, and/or the carriage 118. The interface sensor 132 can be operable to measure an interaction force, suction force, load or other force between the target article TA and the actuatable article engagement device 112 The measured force can be compared to a predetermined engagement threshold value indicating acquisition of the target article by the suction assets (e.g., the actuatable article engagement device 112). If the measured force is greater than or equal to the predetermined engagement threshold value, the computing device 32 can determine that the target article TA is in sufficient contact with or being sufficiently held by the actuatable article engagement device 112. Additionally, in response to the measure force meeting the predetermined engagement threshold value, it can be indicated that a sufficient gap G is opened to receive the extensible member 106B. The extensible member 106B can be extended in response to the measured engagement force reaching a value that is greater than or equal to the predetermined threshold value.

With the extensible member 106B disposed in the gap G, the actuatable article engagement device 112 can be operated to move toward the support platform 106, as shown in FIG. 6D, to move the target article TA toward the support platform 106 and/or to move the target article TA further onto the support platform 106, particularly the stationary member 106A until a state of acquisition is achieved, in which forces acting on the target article from the end effector 100 are sufficient to counter collective forces acting on the target article TA with the target article TA resting on and supported by the platform 106, which may include the stationary member 106A and the extensible member 106B. Movement of the actuatable article engagement device 112 and the target article toward the support platform 106 can mean movement in one or more degrees of freedom. For example, the actuatable article engagement device 112 can be actuated to move along a first axis X (i.e., horizontally in the view shown in FIG. 6D) relative to the arm 102 (i.e., the actuatable article engagement device 112 can be retracted) by one or more actuators operable to move the actuatable article engagement device 112 toward the support platform 106 (in a direction towards the support bridge 101). Alternatively, or in addition to this, the actuatable article engagement device 112 can be actuated to move along a second axis Y (i.e., downward or vertically in the view shown in FIG. 6D) toward the support platform 106 by retracting one or more lift members 101A, 101B, or 101C of the support bridge 101. In other words, urging or further the target article TA against the support platform 106 by moving a first lift member 101A of the support bridge 101 relative to a second lift member 101B of the support bridge 101 by operation of an actuatable joint 124 coupling the first lift member 101A and the second lift member 101B together to facilitate movement of the first lift member 101A relative to the second lift member 101B in the translational degree of freedom. Alternatively, or additionally, urging the target article TA against the support platform 106 can be accomplished by moving a second lift member 101B of the support bridge 101 relative to a third lift member 101C of the support bridge 101 by operation of an actuatable joint 126 coupling the second lift member 101B and the third lift member 101C together to facilitate movement of the second lift member 101B relative to the second lift member 101C in the translational degree of freedom.

Movement of the actuatable article engagement device 112 can compress the target article TA between the arm 102 and the support platform 106 and can provide an engagement force on the target article TA. The compression of the target article TA between the arm 102 and the support platform 106 can act to provide an engagement force sufficient to hold the target article TA to counter collective forces acting on the target article TA and to allow for movement and/or manipulation of the target article TA from one location to another. For example, in a case in which the suction force SF only partially lifts the target article TA off of the other article BA, the target article TA may be prone to falling off of the suction assets 120 were the end effector 100 moved away from the other article BA without fully capturing the target article. However, the compression of the target article TA between the actuatable article engagement device 112 and the support platform 106 can comprise an engagement force sufficient to counter collective forces acting on the target article TA from gravity, other surfaces, other articles, or other forces from the external environment.

Again, the end effector 100 can further comprise a sensor 130 that can be deployed and that is operable to measure the force acting on the article (e.g., a downward force) by the article interface system 110. The sensors 130 and 132 can facilitate the maintaining of the article interface system 110 in contact with the target article TA by sensing the force applied thereto and providing the computing device 32 (i.e., controller) information to maintain this force at a certain threshold or within a certain range of forces, such that the article interface system 110 does not come out of contact with the target article TA. For example, if the force applied falls below a certain given threshold, the negative pressure source 116 can be actuated to increase the suction force to in turn increase the engagement force between the actuatable article engagement device 112 and the target article TA. Additionally, or alternatively, the support bridge 101 can be retracted to the engagement force between the target article TA and the support platform 106. Conversely, if the applied force is beyond a given threshold then the actuatable article engagement device 112 and/or the support bridge 101 can be actuated to reduce the applied force. The threshold for increasing the applied force on the target article TA can be the same or different from the threshold for decreasing the applied force on the target article TA (i.e., the force can be kept within a certain range by the computing device 32 (i.e., controller)).

The load sensor 130 can be disposed on or otherwise associated with any part of the end effector 100 that is suitable for measuring an engagement force acting between the article TA and the support platform 106. It is to be understood that, based on every force having an equal and opposite force, the load sensor 130 can be placed anywhere on the end effector 100 where the engagement force acting on the target article TA by any part of the end effector 100 can be measured (e.g., load sensor can be located on the support platform 106 (e.g., on either of the stationary member 106A or the extensible member 106B) on the arm 102, on the support member 104, on the carriage 118, on a suction asset 120, on the support bridge 101, or on any other location suitable for measuring the engagement force between the target article TA and the support platform 106). The engagement force can be indicative of, or can be used to determine a state of acquisition of the target article TA. The engagement force between the target article TA and the support platform 106 can be compared (i.e., by the controller) to a stored acquisition threshold value indicating acquisition, or in other words, a level at which the engagement force is strong enough to counter collective forces acting on the target article. At a point at which the measured engagement force equal to or greater than the acquisition threshold value, the target article TA can be manipulated and moved by the end effector 100 without the target article TA falling out of the end effector 100. At the point shown in FIG. 6D, the engagement force can be strong enough to counter the collective forces and the target article TA can be said to be acquired. This can be indicated by the measured engagement force being greater than or equal to the stored acquisition threshold value.

The robotic end effector 100 need not actively monitor the engagement force between the target article TA and the support platform 106 using the load sensor 130. Furthermore, the robotic end effector 100 need not control the level of the engagement force based on readings from the load sensor 130 in order to adequately acquire the target article TA at a level that counters collective forces acting on the target article TA. Alternative to using the load sensor 130 to monitor the force between the target article TA and the support platform 106, actuators (e.g., any of the actuators described herein to acquire a target article) can be limited to applying only a certain force. Similarly, the negative pressure source 116 can be limited to only applying a certain level of suction.

In a case where a user has determined, through experimentation a safe level of engagement force to apply to articles in a certain application, the actuators of the robotic end effector can be selected, configured, geared, or otherwise limited to only apply a force at the known safe level for acquiring the article. For example, in a case in which the articles being acquired are luggage or baggage of the type used in air travel, a user may determine that any such article can be safely handled with an applied force of 100 psi. Luggage and bags used in air travel are typically designed to withstand significant clamping forces. Since they are typically stacked in carts and in airplanes, airline luggage is made to accommodate the weight of numerous bags stacked on top of them without failing. The user can further determine that the 100 psi force would be a safe level for any bag or article, regardless of size or material, that the robotic end effector may encounter in the airline baggage handling context. In such a situation, the one or more actuators and/or the negative pressure source of the robotic end effector can be selected or configured such that the applied force to the article is limited to the safe level (e.g., 100 psi) engagement force. Accordingly, articles would always be acquired with the safe level engagement force and the load sensor 130 and force control features could be bypassed in or removed from the robotic end effector, thereby simplifying the design and operation of the robotic end effector.

It is to be understood that the safe level of engagement force can be context or application dependent and the actuators or other systems of the robotic end effector can be selected, calibrated, configured, or limited to an appropriate safe level of engagement force depending on which context or application the end effector is being used in. Therefore, the safe level is not intended to be limited by this disclosure in any way. The actuators can be limited to a safe level of engagement force either mechanically, electrically, hydraulically, or pneumatically. Additionally, a computer program used to control the end effector can be operated to set limits on the force applied by the end effector to an article. In other words, the force applied to the target article by the end effector can be limited to a safe level of engagement force, predetermined by a user, in any way without any intended limitation. Although the target article TA can be said to be acquired at the step shown in FIG. 6D, further steps can be executed in order to more fully and reliably hold or secure the target article TA in the end effector 100. For example, as shown in FIG. 6E, the target article TA can be moved toward the support bridge 101 by actuation of the actuator 107 to operate the joint 105 and move (i.e., retract) the carriage 118 toward the support bridge 101 relative to the first support member 104. As recited above, the actuatable article engagement device 112 that is moveably coupled to the first support member 104 of the arm 102 at an actuatable joint 105 can be actuated by actuator 107 to move relative to the first support member 104, in order to move the actuatable article engagement device 112 from a first retracted position away from the target article TA (see FIGS. 4C and 4E) to a second extended position over the target article (see FIG. 6A) in which the suction assets 120 are positioned adjacent the target article TA to apply a suction force to the target article TA and to temporarily secure the target article to the article interface system 100 and the arm 102 via the suction assets 120 and the applied suction force SF. In a subsequent step shown in FIG. 6E, after the target article TA is secured to the article interface system 110 and the arm 102 via the suction assets 120 and the applied suction force SF, the actuatable article engagement device 112 (e.g., including the carriage 118) can be moved relative to the first support member 104 of the arm 102 from the second extended position (shown in FIG. 6A) back to the first retracted position (shown in FIGS. 4C-4E). This movement from the second position to the first position can be done while the negative pressure source 116 continues to generate a suction force at each of the suction assets 120 to secure the target article TA to the actuatable article engagement device 112, thus effecting movement of the target article TA as well. Therefore, movement of the actuatable article engagement device 112 also can move the target article TA engaged with the suction assets 120 further onto the support platform 106, namely onto or further onto the stationary member 106A of the support platform 106, to provide additional support for the target article TA. The support platform 106 can include one or more rollers or other friction reducing elements to facilitate movement of the target article TA relative to the support platform 106.

As recited elsewhere in the disclosure, a load sensor 130 can be used to measure a force between the target article TA and the support platform 106 to determine a state of acquisition of the target article TA based on comparing the force to a predetermined acquisition threshold value indicating acquisition of the target article on the support platform. The load sensor 130 can additionally or alternatively be compared to an initial support threshold value indicating initial support of the target article TA by the support platform 106. Before the target article TA reaches the acquisition threshold value indicating acquisition of the target article TA, the target article TA can be supported by the support platform 106 by a smaller force at a point at which the target article TA begins to be supported by the support platform 106. At a point at which the initial support threshold value is met, a state of the target article is indicated at which the target article TA is not supported solely by the actuatable article engagement device 112 and the actuatable article engagement device 112 can be manipulated (e.g., moved, vibrated, or a combination of these) to pull the target article TA further onto the support platform 106 as shown in FIG. 6E.

Accordingly, the process of acquiring the target article TA by the end effector 100 can include comparing the measured force between the target article TA and the support platform 106 to a predetermined threshold value (i.e., an initial support threshold value that can be less than the acquisition threshold value) indicating sufficient force between the target article TA and the support platform 106 to counter at least some of the collective forces acting on the target article. In response to the load meeting or exceeding the predetermined initial support threshold value, the actuatable article engagement device 112 can be moved from the second extended position in FIG. 6D to the retracted first position in FIG. 6E, in which the target article TA moves toward the support bridge 101 by retracting the actuatable article engagement device 112 relative to the first support member 104 of the arm 102 in at least one degree of freedom (e.g., a translational degree of freedom), and in which the target article TA is at least partially supported on the stationary member 106A of the support platform 106. As can be seen, the target article TA is also moved relative to the article SS.

The acquisition, initial support, and engagement threshold values can be set to any desired value based on need, such as the type of article being acquired by the end effector 100, the ability of the end effector 100 to maintain the target article TA in contact with the capture device 106, or others. The state of acquisition, or the state in which the acquisition threshold value is met, is defined as a state in which the forces acting on the target article TA from the end effector 100 are sufficient to counter collective external forces acting on the article. The collective external forces acting on the article can include gravitational forces acting on the article, stiction between the target article TA and articles BA or a ground or other initially supporting surface in contact with one or more surfaces of the target article TA, and/or compressive forces acting on the target article TA from any surrounding articles BA. At a point at which the collective external forces acting on the target article TA are countered, the end effector 100 has a strong enough hold on the target article TA to lift, move, transport, or otherwise manipulate the target article from its current or first position to a new or second position, such as that position intended to be achieved for subsequent release of the target article TA.

The forces acting on the target article TA from the end effector 100 necessary to overcome the other collective forces acting on the target article TA can be a value determined by the user experimentally or by experience, or these can be derived and achieved and adjusted in real-time using sensor output data from a plurality of sensors deployed within the end effector 100, wherein the computing device 32 (i.e., controller) autonomously determines the forces necessary to achieve all of the different stages between initial contact with the target article TA and a state of acquisition of the target article TA based on real-time input from the sensors. Using the load sensor 130, a state of acquisition of the target article can be determined to be achieved upon the load sensor 130 detecting a predetermined acquisition value on the target article TA that sufficiently counters collective external forces acting on the target article TA.

The forces acting on the target article TA from the article interface system 110 necessary to allow for engagement of the article interface system 110 with the target article TA and/or to open the gap G, or in other words the engagement threshold value, can be a value determined by the user experimentally or by experience, or these can be derived and achieved and adjusted in real-time using sensor output data from a plurality of sensors deployed within the end effector 100, wherein the computing device 32 (i.e., controller) autonomously determines the forces necessary to achieve all of the different stages between initial contact with the target article TA and a state of acquisition of the target article TA based on real-time input from the sensors.

The forces acting on the target article TA from the end effector 100 necessary to allow for the article interface system 110 to move from the second position (FIG. 6F) to the first position (FIG. 6E), or in other words the initial support threshold value, can be a value determined by the user experimentally or by experience, or these can be derived and achieved and adjusted in real-time using sensor output data from a plurality of sensors deployed within the end effector 100, wherein the computing device 32 (i.e., controller) autonomously determines the forces necessary to achieve all of the different stages between initial contact with the target article TA and a state of acquisition of the target article TA based on real-time input from the sensors.

Additional features and modifications to the end effector 100 can be used to facilitate capture, support, and retention of the target article TA in addition to, or alternatively to, the other features described herein. For example, various modifications can be made to the extensible member 106B to facilitate insertion of the extensible member 106B between the target article TA and the other article BA. As shown in FIG. 2, the extensible member 106B can include a leading-edge roller 140 disposed at a leading edge 142 of the extensible member 106B. The roller 140 can be rotatable to reduce friction as the extensible member 106B is inserted into the gap G, thereby making insertion of the extensible easier and requiring less force to achieve support of the target article TA with the support platform 106. The roller 140 can be a powered or actuatable roller that reduces friction between the target article and the support platform 106 and that actively facilitates movement of the target article relative to the support platform 106, or it can be a passive roller that helps reduce friction, but is not actuatable.

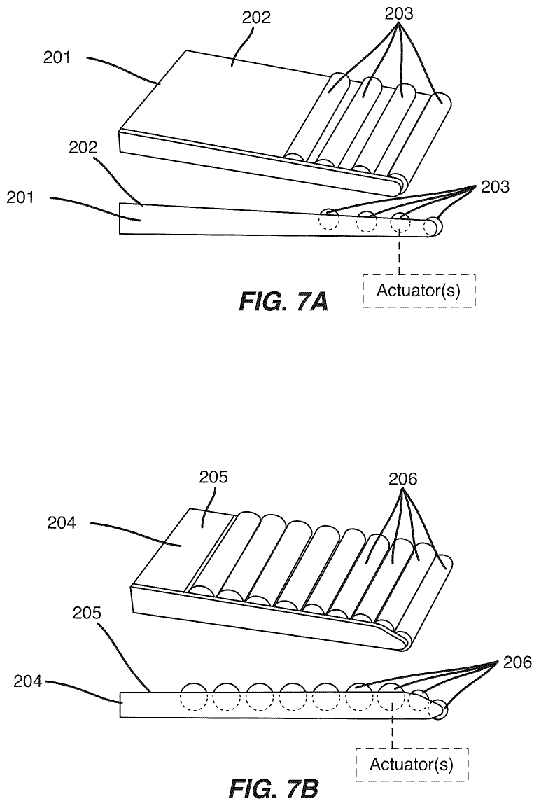

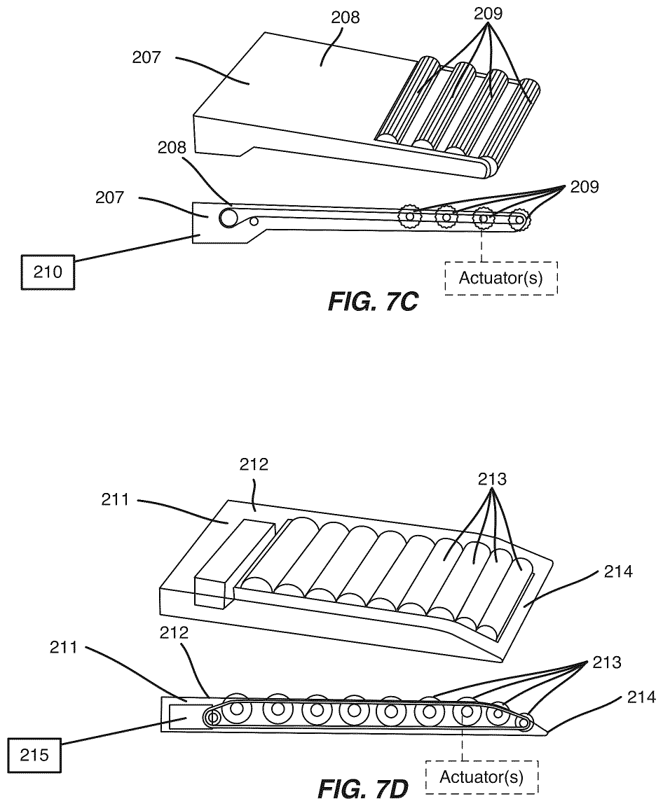

Other alternative configurations are contemplated by this disclosure for the support platform, the stationary member of the support platform, or the extensible member of the support platform. While the examples discussed with respect to FIGS. 7A-10 below refer to extensible members, it is to be understood that the descriptions and disclosed elements are equally applicable to be implemented on the support platform and the stationary member thereof. The disclosure of FIGS. 7A-10 is not intended to be limited to only extensible members. FIGS. 7A-7D illustrate various alternative configurations of extensible members including a plurality of rollers. FIG. 7A illustrates an alternative configuration of an extensible member 201. As shown in FIG. 7A, an alternative extensible member 201 can include a plurality of rollers 203 rotatably coupled to the extensible member 201 and extending from an upper surface 202 of the extensible member 201. The rollers 203 can include at least one leading-edge roller to facilitate insertion of the extensible member 201 into the gap G. Additionally, the rollers can be spaced apart from each other on the upper surface 202 of the extensible member 201. The rollers 203 can be passive (non-powered or non-actuatable) or powered (actuatable) rollers.

FIG. 7B illustrates an alternative configuration of an extensible member 204. As shown in FIG. 7B, an alternative extensible member 204 can include a plurality of rollers 206 rotatably coupled to the extensible member 204 and extending from an upper surface 205 of the extensible member 204. The rollers 206 can include at least one leading edge roller to facilitate insertion of the extensible member 201 into the gap G. Additionally, the rollers can be spaced apart at smaller distances than those shown in FIG. 7A with respect to extensible member 201. The rollers 203 and the rollers 206 can roll under an applied force to reduce friction as the extensible member 201 engages with the target article TA. The rollers 203 can be passive or powered rollers.

FIG. 7C illustrates an alternative configuration of an extensible member 207. As shown in FIG. 7C, an alternative extensible member 207 can include a plurality of rollers 209 rotatably coupled to the extensible member 207 and extending from an upper surface 208 of the extensible member 207. The rollers 209 can include at least one leading edge roller to facilitate insertion of the extensible member 207 into the gap G. Additionally, the rollers 209 can be spaced apart from each other on the upper surface 208 of the extensible member 207. The rollers 209 can be passive or powered rollers.

FIG. 7D illustrates an alternative configuration of an extensible member 211. As shown in FIG. 7D, an alternative extensible member 211 can include a plurality of rollers 2013 rotatably coupled to the extensible member 211 and extending from an upper surface 212 of the extensible member 211. The rollers 213 may omit any leading-edge roller and can instead include a tapered leading edge 214 to facilitate of the extensible member 211 into the gap G. The rollers 209 and the rollers 213 can be passive (non-powered) rollers, or they can be active rollers that are powered by respective actuators 210 and 215 to drive a target article either on to or off of the extensible members 207 or 211. With the rollers 209 and 213 being powered rollers, insertion of the extensible members 207 and 211 can be further facilitated by the rollers. In a case in which a leading edge roller is included (e.g., as in extensible member 207) the leading edge roller can be driven to both facilitate lifting the target article TA off of the other article BA and to facilitate driving the target article TA on to the extensible member 207.

As shown in FIGS. 7A-7D, the one or more rollers (e.g., 203, 206, 209, and 213) can be one or more upper rollers extending from an upper surface of the support platform configured to engage with the target article. Although not shown, it is to be understood that the one or more rollers can also include one or more lower rollers extending from a lower surface of the support platform opposite to the upper surface and configured to engage with the surface (e.g., article BA) in support of the target article TA. Or, a combination of upper and lower rollers is contemplated. Indeed, extensible members can be configured to have only upper rollers, only lower rollers, or both upper and lower rollers. Both the upper rollers and the lower rollers can be located in conjunction with each other such that the upper rollers interface with the target article TA and the lower rollers interface with the article BA.

The one or more rollers (e.g., 203, 206, 209, and 213) can be passive rollers, powered or actuatable rollers, or a combination of these. For example, the upper rollers and/or the lower rollers can be passive (i.e., non-powered), or they can be powered and actuatable such that they actively operate to facilitate insertion into the gap G.

Furthermore, any powered rollers (e.g., the upper and lower rollers) can each be driven selectively (i.e., when needed or desired, at select rates, at select times, etc.) for different purposes. For example, the upper rollers can be driven to lift and acquire the target article TA while the lower rollers can be driven to hold the article BA in place during movement of the target article TA onto the extensible member.

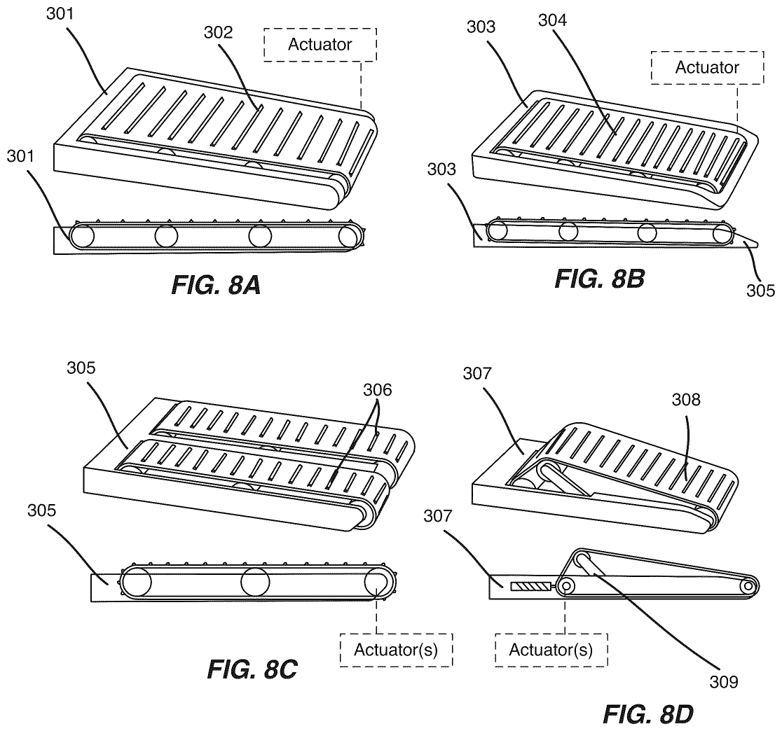

The one or more rollers discussed herein that are associated with the support platform 106 can be at least one of a wheel-type roller (as illustrated in FIGS. 7A-7D) or a belt-type roller. Moreover, as indicated, the one or more wheel-type or belt-type rollers can be powered and actuatable or passive (non-powered), or a combination of passive and powered rollers. FIGS. 8A-8D illustrate various configurations of belt-type rollers on an extensible member. FIG. 8A illustrates an extensible member 301 having a single belt roller 302 that extends to a leading edge of the extensible member 301. FIG. 8B illustrates an extensible member 303 having a single belt roller 304 and a tapered leading edge 305. FIG. 8C illustrates an extensible member 305 having dual belt rollers 306 that both extend to a leading edge of the extensible member 305. FIG. 8D illustrates an extensible member 307 having a single belt roller 308 and an actuatable tension roller 309 that can raise, lower, and increase or decrease tension on the belt roller 308 and to facilitate bias the front of a target article TA upwards as it is driven by the belt roller 308. In any of the above configurations, the extent of the belted area could be just at a front portion of the extensible member or any percentage of the extensible member. Furthermore, more than one belted area can be present (as in FIG. 8C) to facilitate straightening of a target article TA that is placed crooked on the extensible member 305. A crooked article can be straightened by driving the dual belts 306 at different rates from each other.

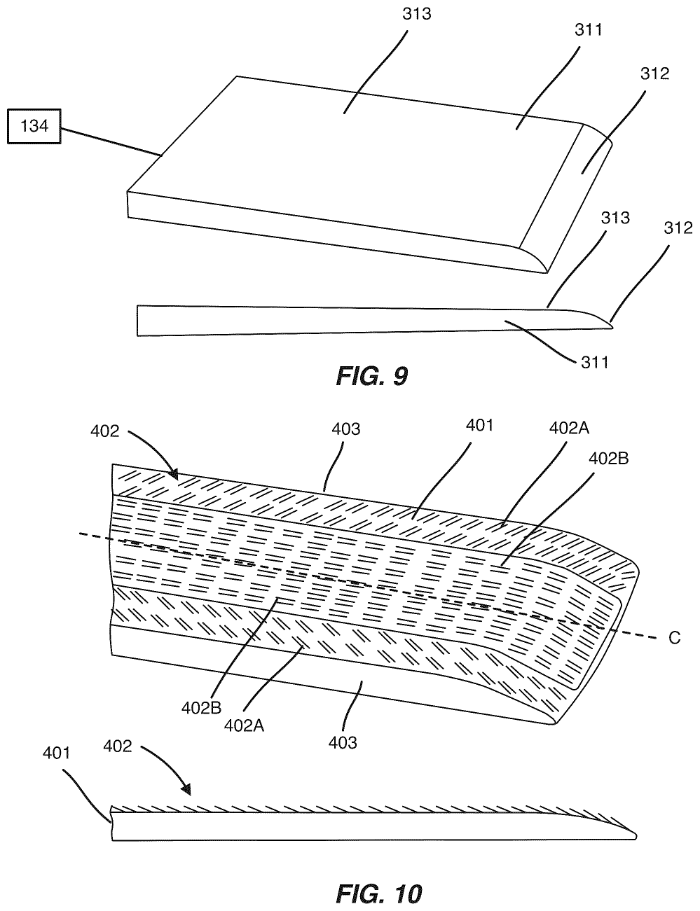

An alternative extensible member 301 is illustrated in FIG. 9. The extensible member 301 can be a stiff plate with a tapered leading edge 302 and a smooth upper surface 303 to reduce friction and facilitate insertion of the extensible member 301 in to a gap between the target article and a surface in support of the target article. As described elsewhere in this disclosure, a vibrational actuator (e.g., vibrational actuator 134), or alternatively an actuator of the extensible member having a vibration mode, can be operable to vibrate the extensible member (such as, optionally, extensible member 301) during extension of the extensible member into a gap between a target article and a surface in support of the target article TA to facilitate insertion of the extensible member between the target article and the surface in support of the target article. Vibration of the extensible member 301 can help to overcome friction and stiction forces between the target article TA and the surface or other article in support of the target article TA.

In at least some cases, pneumatic actuation (such as by actuator 129 or vibrational actuator 134) could provide the horizontal displacement of the extensible member relative to the stationary member of the support platform. It is to be understood that a pneumatic or hydraulic actuator (such as actuators 129 or 134) can be equipped with valving that operates to produce a high frequency component to induce a vibration in the extensible member as it is extended between the target article TA and another article or surface BA to allow it to better break through friction and stiction between the surfaces of the articles. In some cases, the vibrational actuator used to induce vibration on the extensible member can be separate from the actuator used to extend the extensible member. In other cases, the vibration and the extension of the extensible member can be achieved by a single pneumatic or hydraulic actuator that comprises valving to induce vibrations during operation.

Frequencies and waveforms of the vibration induced by a vibrational actuator (or an actuator having a vibration mode) can be tuned to move in desired directions. For example, the vibrational actuator (or an actuator having a vibration mode) can be operable to vibrate the support platform or extensible member with a vibratory waveform operable to vibrate the target article in a direction on to the support platform during capture of the target article. Similarly, the vibrational actuator (or an actuator having a vibration mode) can be operable to vibrate the support platform with a vibratory waveform configured to vibrate the target article in a direction off of the support platform during release of the target article. For example, the vibratory waveform can be made to extend the extensible member quickly and retract it comparatively slowly to produce a collection of net small displacements of the bag in the desired direction, (i.e., onto the extensible member during acquisition of the article and off of the extensible member during release of the target article).

In addition to the vibration of the extensible member, certain extensible members can comprise a surface configuration that biases the target article in a desired direction (e.g., onto or further onto the extensible member of the support platform, onto or further onto the stationary member of the support platform, toward the support bridge, or off of any of these). For example, as shown in FIG. 10, an extensible member 401 can include a plurality of protrusions or textures, hereinafter referred to as surface assets 402, that are oriented in a direction to bias the target article onto the extensible member 401. The surface assets 402 can also be included on a stationary member of a support platform to which the extensible member 401 is coupled. The surface configuration can further bias the target article toward a longitudinal center C of the extensible member 401 with respect to lateral edges 403 of the extensible member 401.

For example, the plurality of surface assets 402 can impart the surface configuration to the extensible member 401. For example, the plurality of surface assets 402 can be oriented in a first direction to bias the target article in the first direction, such as toward the longitudinal center C. As shown in FIG. 10, a portion of the surface assets near lateral edges 403 of the extensible member 401 are oriented inward toward the longitudinal center C of the extensible member 401. The plurality of surface assets 402 of the extensible member 401 can include at least a first surface asset 402A oriented in a first direction to bias the target article in the first direction (e.g., toward a longitudinal center C of the extensible member 401) and a second surface asset 402B oriented in a second direction different from the first direction to bias the target article in the second direction (e.g., on to or off of the extensible member 401, or toward a support bridge of an end effector) due to the surface assets 402B. Vibration of the extensible member 401 can further operate to bias the target article toward the longitudinal center of the extensible member 401 due to the surface assets 402A. In other words, vibration of the support platform can operate to create a net collection of small displacements of the target article toward the center of the extensible member 401 and toward a support bridge of an end effect coupled to the extensible member 401.

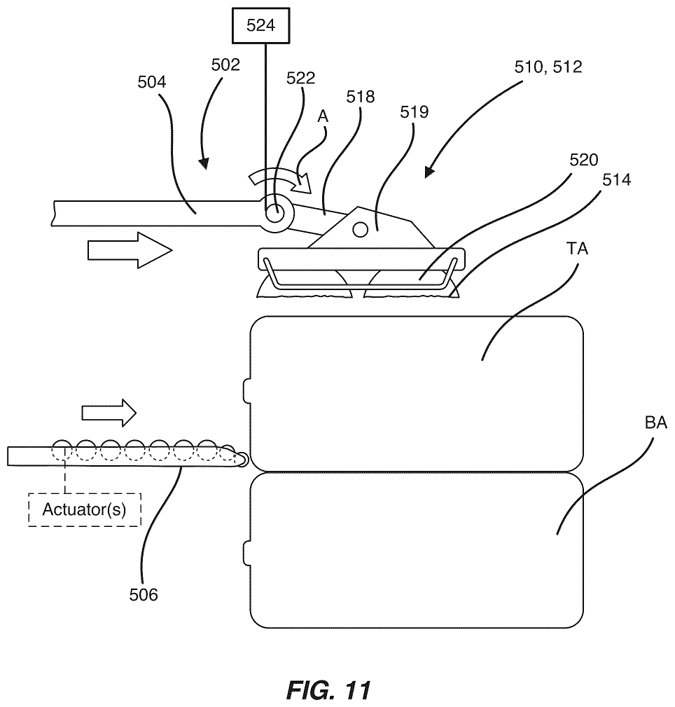

Alternative configurations of the arm 102 are also contemplated within the scope of this disclosure. FIG. 11 illustrates a partial view of an end effector with an alternative arm 502. As shown the arm 502 can include a first support member 504. The first support member 504 of the arm 502 can be movably coupled to an actuatable article engagement device 512. The actuatable article engagement device 112 can comprise an articulating arm 518 coupled to the first support member 504 of the arm 502, the articulating arm 518 providing support for an actuatable article engagement device 512. The actuatable article engagement device 512 can be operable to interface with the target article TA to facilitate movement of the target article TA on to a support platform 506.

As shown in the figures, the actuatable article engagement device 512 can be supported by or from the articulating arm 518. The articulating arm 518 can be moveably coupled to the first support member 504 of the extendable arm 502, at the actuatable joint 522. The actuatable joint 522 can be operated by the actuator 524 to facilitate relative movement between the first support member 504 and the article interfacing system 510, comprising the articulating arm 518 and the actuatable article engagement device 512, in at least one degree of freedom (e.g., a rotational degree of freedom A). The method for moving the actuatable article engagement device 512 to engage with the target article TA can include operating the actuatable joint 522 to position the article interface system 510, including the articulating arm 518 and the actuatable article engagement device 512, relative to the first support member 504 to position the article interface system 510 to cause an article interface surface 514 of the actuatable article engagement device 512 to engage with the target article TA. The actuatable article engagement device 512 can further include a carriage 519 having suction assets 520 coupled thereto. Although not shown, it is to be understood that the carriage 519 and the suction assets 520 can be configured similarly to carriage 118 and suction assets 120 of the end effector 100. Although not shown, the suction assets 520 can be in pneumatic communication with a negative pressure source to facilitate producing a suction force at each of the plurality of suction assets 520. In one example, the actuator 524 can be configured or controlled to comprise a vibration or oscillation mode in which the actuator 524 can be operated in a manner so as to vibrate or rapidly oscillate the article interfacing system 510 and/or the first support member 504 of the arm 518, as well as to effectuate the rotation of the article interface system 510 and the first support member 504 relative to one another.

For example, the actuator 524 can rotate the articulating arm 518 relative to the first support member 504 to move the articulating arm 518 and/or the actuatable article engagement device 512 toward the target article TA to engage the article interface surface 514 with the target article TA. As discussed further below, engagement of the actuatable article engagement device 512 with the target article TA can further comprise actuating the actuatable joint 522 to cause the article interface system 510, namely the actuatable article engagement device 512 via further actuation and rotation of the articulating arm 518, to exert a force (in this case a downward force) on the target article

TA as needed or desired following contact of the actuatable article engagement device 512 with the target article TA. Accordingly, the actuatable article engagement device 512 can be rotationally coupled to the first support member 504 instead of slidably coupled as shown in FIG. 2. With the suction assets 520 exerting a suction force on the target article TA from a negative pressure source, the articulating arm 518 can be operated to rotate upward by operation of the actuator 524 and the actuatable joint 522 in order to lift the target article TA off of the other article BA to expose a gap for the support platform 506 to enter between the target article TA and the other article BA to support the target article TA.

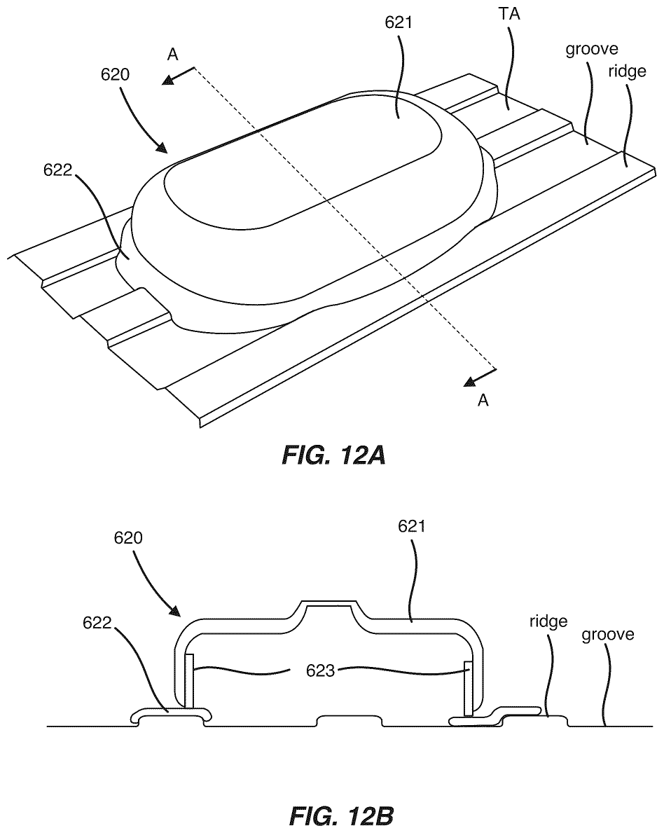

Alternative configurations and examples are now described for the suction assets with reference to FIGS. 12A and 12B. As illustrated in FIG. 12A, an exemplary suction asset 620 having a cupped receptacle 621 and further comprising a second compliant skirt 622 made of a compliant material. FIG. 12A illustrates the suction asset 620 in engagement with a target article TA. As shown, the target article TA can have a textured surface including grooves and ridges that can make it difficult for a suction asset to suck to the surface of the target article TA. The skirt 622 can be made of a compliant material configured to deform and shape to the surface texture of the target article TA. FIG. 12B illustrates a cross sectional view of the suction asset 620 taken along line AA. As shown in FIG. 12B and 12a, the skirt 622 can be disposed at an edge of the cupped receptacle 621 and can at least partially surround a first compliant skirt 621. In situations in which the skirt 623 may be to stiff or disposed such that the ridges and grooves of the target article TA interfere with the suction asset 620 sucking to the target article TA, the skirt 622 can conform to the ridges and grooves of the target article TA to ensure suction between the suction asset 620 and the target article TA without leaks or compromises in the seal between the target article TA and the suction asset 620.

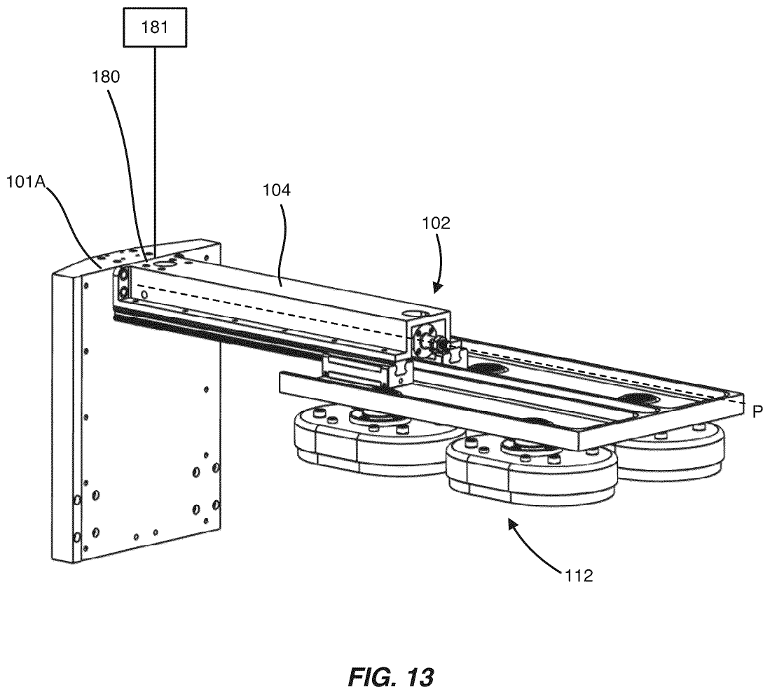

A modification to the end effector 100 of FIG. 2 is illustrated in FIG. 13. In FIG. 2, the arm 102, via the first support member 104, is coupled to the support bridge 101 at the lift member 101A. The arm 102 can be rigidly coupled to the lift member 101A to remain in a fixed orientation relative to the lift member 101A. In FIG. 13, the first support member 104 of the arm 102 can be rotatably coupled to the lift member 101A at a joint 180. The joint 180 can be configured to allow rotation of the arm 102 and at least a portion of the actuatable article interface device 112 relative to the first lift member 101A along an axis P extending longitudinally through the first support member 104. The joint 180 can be configured to rotate passively within a range of rotational positions when under an applied force. Alternatively, or additionally, the joint 180 can be an actuatable joint actuated by actuator 180 operable to cause the first support member 104 to rotate or move relative to the first lift member 101A. It is to be understood that although the first support member 104 is rotatably coupled to the first lift member 101A, that rotation of the actuatable article interface device 112 relative to the first lift member 101A can also be achieved by rotatably coupling the actuatable article interface device 112 to the arm 102 (e.g., to the first support member 104).

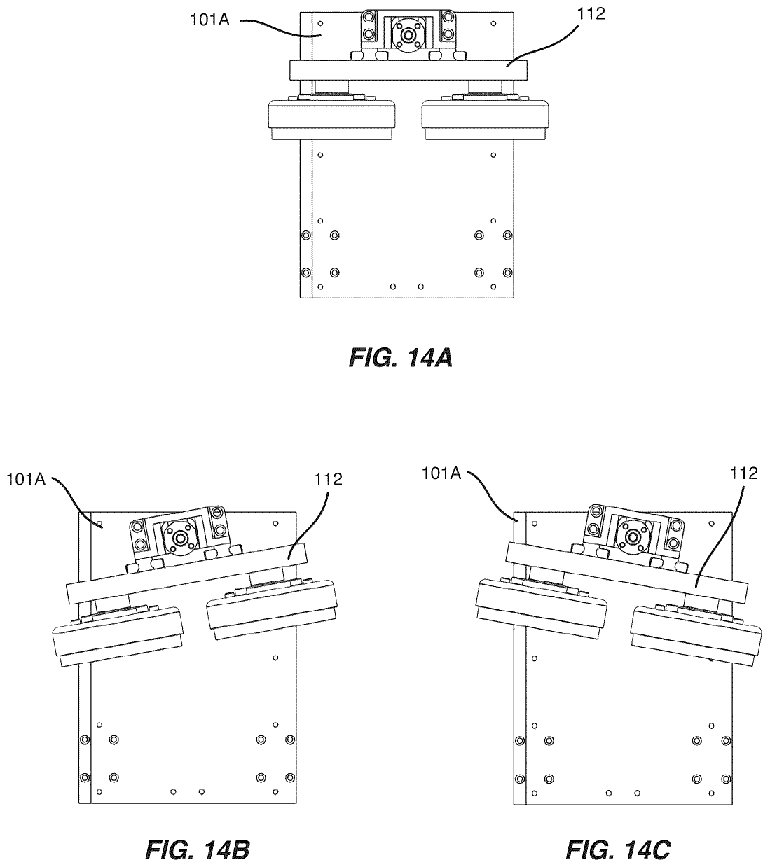

FIGS. 14A-14C illustrate various positions of the actuatable article engagement device 112 relative to the first lift member 101A via the first support member 104 of the arm 102 being rotatably coupled to the lift member 101A at a joint 180 as set forth above, and shown in FIG. 13. FIG. 14A illustrates the actuatable article engagement device 112 in a neutral position relative to the first lift member 101A. FIG. 14B illustrates the actuatable article engagement device 112 rotated counter clockwise relative to the first lift member 101A. FIG. 14C illustrates the actuatable article engagement device 112 rotated clockwise relative to the first lift member 101A. The rotation of the actuatable article engagement device 112 facilitates proper engagement with a target article that may not be strictly aligned with the actuatable article engagement device 112 positioned as shown in FIG. 14A. For example, articles to be acquired by an end effector can sometimes deviate from a strictly horizontal position due to human handlers not taking the desired care, due to the shape of the article, or as a result of accelerations, decelerations, and jostling of the article during transit from one location to another. The configurations illustrated in FIGS. 13-14C facilitate acquiring articles that are tilted or shaped irregularly. It is to be understood that suction assets (e.g. suction assets 120 of FIG. 2) can have some degree of flexion and tilt from side to side and/or front to back and can have a certain amount of vertical travel to accommodate tilting in the article to be acquired. Additionally, the compliant elements of the suction assets (e.g., compliant skirt 622 and 623) can deform to some degree to accommodate tilting of an article to be acquired.

To the extent that an article's tilt exceeds what is accommodatable by the tilting, vertical travel, and deformation capabilities of the individual suction assets, then the rotatable arm 102 and actuatable article engagement device 112 shown in FIGS. 13-14C can be used to further facilitate acquiring an article. As described above, the rotatable arm 102 and actuatable article engagement device 112 can be free to swivel about the joint 180 along axis M to, thereby, self-align to a surface of the article. The joint 180 can further be spring-loaded or include a biasing member configured to bias the arm 102 and the actuatable article engagement device 112 to have a default alignment (e.g., the alignment shown in FIG. 14A). The biasing force of the joint 180 can be set to an amount that allows proper interfacing with the article and that is sufficient to exert a restoring force to the default alignment once the article is lifted from its original position. Alternatively, the actuator 181 of the joint 180 can be controlled during engagement with an article to allow free swiveling of the arm 102 about the joint 180, and then can be driven to restore the bag to the default position. Additionally, cameras, LIDAR sensors, or other visual sensors can be used to sense a position of the article during retrieval to orient the actuatable article engagement device 112 to align with a surface of the article. The visual sensors can also be used to position the article to the default position upon engagement with the actuatable article engagement device 112.

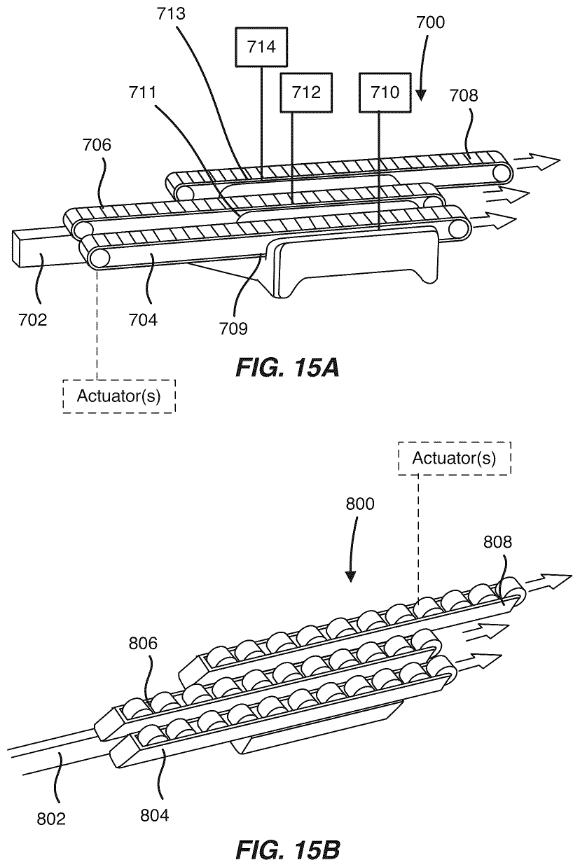

Alternative embodiments of support platforms are contemplated within the scope of this disclosure. FIG. 15A illustrates an alternative support platform 700 to the support platform 106 shown in FIG. 2. It is to be understood that, as one example, the support platform 700 can be used to replace the support platform 106 in the end effector 100 of FIG. 2. In other words, the end effector 100 of FIG. 2 can be modified to include a support platform 700 extending away from the support bridge 101 in the first direction and at a position offset from the arm 102 to define a capture volume 108 disposed between the support platform 700 and the arm 102. The capture volume 108 can be configured to receive an article between the arm 102 and the support platform 700.

With reference to the support platform 700, the support platform 700 can include a stationary member 702, which can be coupled to the support bridge 101 of FIG. 2, and a plurality of extensible members 704, 706, and 708. Each of the extensible members 704, 706, and 708 can be moveably coupled to the stationary member 702 and can be operable to extend and retract relative to the stationary member 702. The support platform 700 can further comprise an actuatable joint (i.e., actuatable joints 709, 711, and 713) respectively for each of the extensible members 704, 706, 708. The actuatable joints 709, 711, and 713 can be operable to facilitate movement of their respective extensible members 704, 706, and 708 relative to the stationary member 702 in a translational degree of freedom to facilitate insertion of each extensible member 704, 706, and 708 between a target article and a surface in support of the target article.

In the example shown in FIG. 15A, the extensible members 704, 706, and 708 and the stationary member 702 of the support platform 700 can be moveable relative to one another. It is to be understood that the extensible members 704, 706, and 708 can be moveably coupled to a stationary member 702 in any way in which the extensible members 704, 706, and 708 can be actuatable to move in a direction along an axis of the support platform 700 relative to the stationary member 702 without any intended limitation.

To achieve translation of the extensible members 704, 706, and 708 and the stationary member 702 relative to one another, the extensible members 704, 706, and 708 and the stationary member 702 can be coupled together at respective actuatable joints 709, 711, and 713. Each of the actuatable joints 709, 711, and 713 and the extensible members 704, 706, and 708 can be separately and independently actuatable apart from the other extensible members. Respective actuators 710, 712, and 714 associated with each of the respective actuatable joints 709, 711, and 713, whether being linear, rotational, or other type of actuators, can be operable to impart translational motion between the respective extensible members 704, 706, and 708 and the stationary member 702 to move these relative to one another in at least one degree of freedom (such as a linear or translational degree of freedom, or in other words, a translating degree of freedom). In the example shown, the actuators 710, 712, and 714 can comprise a linear or a rotational actuator operable to extend and retract their respective extensible members 704, 706, and 708 relative to the stationary member 702. In one example, one or more of the actuators 710, 712, and 714 can be configured or controlled to comprise a vibration or oscillation mode in which the actuators 710, 712, and 714 can be operated in a manner so as to vibrate or rapidly oscillate one or more of the extensible members 704, 706, and 708, respectively, and/or the stationary member 702, as well as to effectuate the extension and retraction of the stationary member 702 and the extensible members 704, 706, and 708 relative to one another.

As shown in FIG. 15A, the extensible members 704, 706, and 708 can include belt-type rollers to facilitate acquisition of an article. Alternatively, as shown in FIG. 15B, a support platform 800 can instead be configured with a stationary member 802 and a plurality of extensible members 804, 806, and 808 each comprising wheel-type rollers. The rollers of the support members 700 and 800 can be either powered rollers or passive rollers. It is to be understood that the extensible members 704, 706, and 708 need not include rollers at all but can be smooth members, can have tapered edges, or can have any other configuration described herein to facilitate insertion between a target article and a surface in support of the target article.

The configurations shown in FIGS. 15A and 15B have advantages that if the entire support platform 700 is too wide to acquire a small sized target article, then only a subset of one or more of the extensible members 704, 706, and 708 can be driven to acquire the article. Additionally, some articles may have difficult shapes to deal with that may cause an article to not be adequately acquired by a single extensible member all at once. Additionally, an article may be supported having one end higher than another, or having one end supported on a different surface then the other end of the article and at different heights from each other, such that the article does not have a lower surface oriented in alignment with a single extensible member. Accordingly, the plurality of extensible members 704, 706, and 708 can be actuated independently of each other sequentially and incrementally to provide support for different areas of an article to be acquired. For example, if one end of the lower surface of a article is sitting lower than another end of the article, then a first extensible member 704 can be extended under the end of the bag supported at a lower height in order to lift the lower end of the article to be on a same level or height with the end of the article being supported at a higher level. Once the lower surface of the article is at a common level with the support platform 700, some or all of the extensible members 704, 706, and 708 can then be extended to provide support for the article.

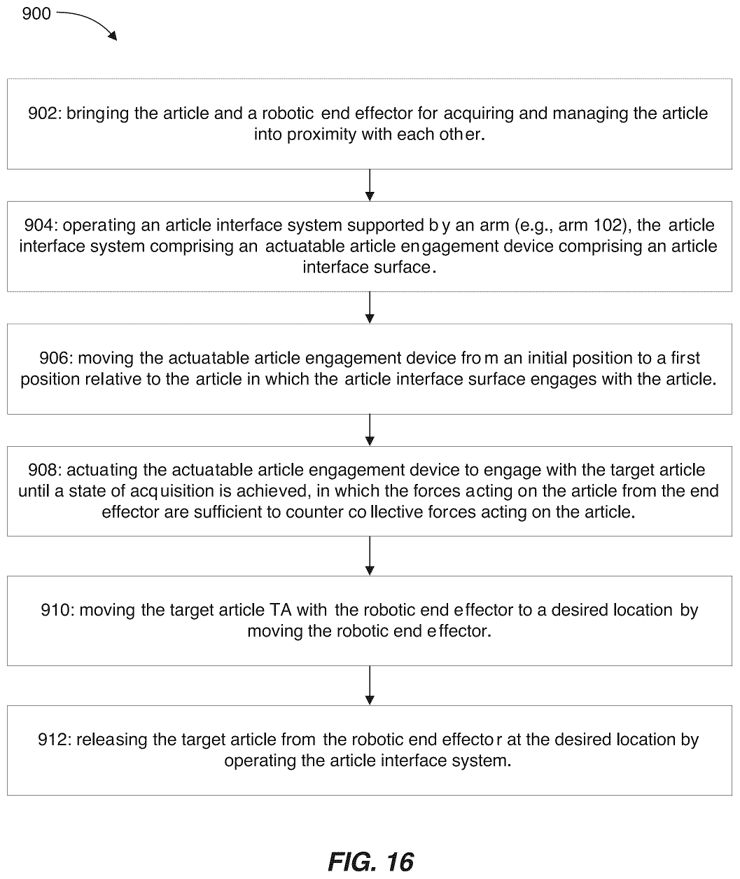

Any of the robotic end effectors described herein configured to include any of the support platforms, support bridges, and article interface systems described herein can be used in any combination to execute a method 900 of acquiring an article. The method 900 is illustrated in FIG. 16. The method 900 can include a step 902 of moving a target article into proximity with a target article TA by moving either the end effector or the target article. The method 900 can further include a step 904 of operating an article interface system (e.g., article interface system 110) supported by an arm (e.g., arm 102 or 502), the article interface system comprising an actuatable article engagement device (e.g., actuatable article engagement device 112) comprising an article interface surface (e.g., article interface surface 114), the actuatable article engagement device being operable to interface with an article to facilitate movement of the article toward the array of rods. Operating the article interface system can include a step 906 of moving the actuatable article engagement device from an initial position to a first position relative to the article in which the article interface surface engages with the article. Operating the article interface system can further include a step 908 of actuating the actuatable article engagement device to move the article against into engagement with the article interface surface (e.g., 114 on the suction assets) until state of acquisition is achieved, in which the forces acting on the article from the end effector are sufficient to counter collective forces acting on the article. Step 908 can also include urging the article against a support platform (e.g., any of the support platforms described herein, including 106, 700, 800, any of extensible members 201, 204, 207, 211, 301, 303, 305, 307, 311, 401, and stationary members 106A) until a state of acquisition is achieved. The method 900 can further include a step 910 of moving the target article TA with the robotic end effector to a desired location by moving the end effector. The method 900 can further include a step 912 of releasing the target article from the end effector at the desired location by operating the article interface system to release the target article TA. Operating the article interface system to release the target article TA can include operating any of the arm 102, the article interface system 110, the support bridge 101, the support platform 106, or any similar or associated mechanism or device described herein that is operable to engage with the target article TA to disengage from, and/or release the target article TA so that the target article is caused to be released from the end effector.

As shown in FIG. 1, the end effector 10 can include a computing device 32 in communication with the systems and devices of the end effector 10 (e.g., one or more of the arm 12, the actuator 14, the article interface system 18, the actuatable article engagement device 20, the actuator 24, the support platform 16, the actuator 15, the support bridge 17, the actuator 21, the sensor 30, and the robotic positioning member interface 26). The computing device 32 can operate to control movement and/or operation of one or more of the arm 12, the actuator 14, the article interface system 18, the actuatable article engagement device 20, the actuator 24, the support platform 16, the support bridge 17, and/or the platform 28 either autonomously, or under the direction of an operator, or both. Additionally, the computing device 32 can operate the sensor 30 (e.g., any of sensors 130, 132, or any other sensors described herein), and receive information, signals, or data from the load sensor 30 to aid in operation of the end effector 10. It is to be understood that any of the end effectors described in this disclosure, or any end effectors operating by principles described in this disclosure, can be operated by a computing device similar to the computing device 32.

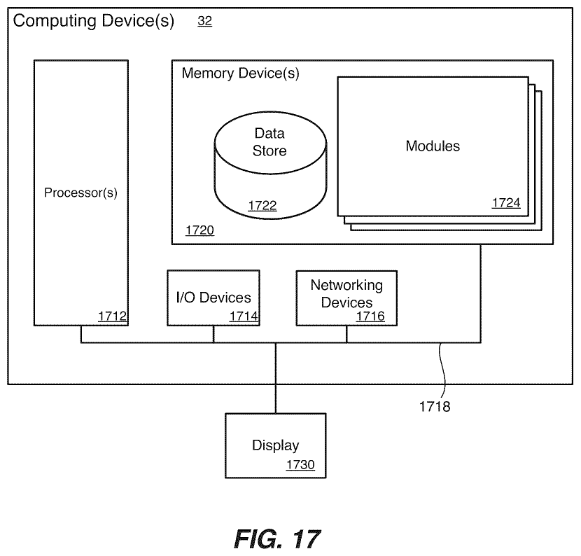

FIG. 17 illustrates such a computing device 32 on which modules of this technology may execute to operate any of the end effectors described herein. The computing device 32 is shown at a high-level and may be used as a main robotic controller and/or a controller for a robotic component. The computing device 32 may include one or more processors 1712 that are in communication with memory devices 1720. The computing device 1710 may include a local communication interface 1718 for the components in the computing device. For example, the local communication interface 1718 may be a local data bus and/or any related address or control busses as may be desired.

The memory device 1720 may contain modules 1724 that are executable by the processor(s) 1712 and data for the modules 1724. In one example, the memory device 1720 can contain a main robotic controller module, a robotic component controller module, data distribution module, power distribution module, and other modules. The modules 1724 may execute the functions described earlier. A data store 1722 may also be located in the memory device 1720 for storing data related to the modules 1724 and other applications along with an operating system that is executable by the processor(s) 1712.

Other applications may also be stored in the memory device 1720 and may be executable by the processor(s) 1712. Components or modules discussed in this description that may be implemented in the form of software using high-level programming languages that are compiled, interpreted or executed using a hybrid of the methods.

The computing device 1710 may also have access to I/O (input/output) devices 1714 that are usable by the computing device 1710. In one example, the computing device 1710 may have access to a display 1730 to allow output of system notifications. Networking devices 1716 and similar communication devices may be included in the computing device. The networking devices 1716 may be wired or wireless networking devices that connect to the internet, a LAN, WAN, or other computing network.

The components or modules that are shown as being stored in the memory device 1720 may be executed by the processor(s) 1712. The term “executable” may mean a program file that is in a form that may be executed by a processor 1712. For example, a program in a higher-level language may be compiled into machine code in a format that may be loaded into a random-access portion of the memory device 1720 and executed by the processor 1712, or source code may be loaded by another executable program and interpreted to generate instructions in a random-access portion of the memory to be executed by a processor. The executable program may be stored in any portion or component of the memory device 1720. For example, the memory device 1720 may be random access memory (RAM), read only memory (ROM), flash memory, a solid-state drive, memory card, a hard drive, optical disk, floppy disk, magnetic tape, or any other memory components.

The processor 1712 may represent multiple processors and the memory device 1720 may represent multiple memory units that operate in parallel to the processing circuits. This may provide parallel processing channels for the processes and data in the system. The local communication interface 1718 may be used as a network to facilitate communication between any of the multiple processors and multiple memories. The local communication interface 1718 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine-readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

With reference to FIGS. 1 and 17, illustrated are various computer, sensor(s), and other system components within a robotic article management system, such as the example robotic article management system 2. In this example, the robotic article management system 2 can comprise components, such as the platform 28, the robotic positioning member 25, the robotic end effector 10, the optional external electrical object/system 29, a system computing device (i.e., a system controller) 4, and one or more sensors 6, such as global positioning sensors (GPS), optical cameras, infra-red (IR) cameras or sensors, LIDAR sensors, pressure sensors, force sensors, inertial measurement unit sensors, rangefinders, and others, and any combination of these. In some examples, each of the platform 28, the robotic positioning member 25, the robotic end effector 10 and the system controller 4 can include some or all of these types of sensors 6. In some examples, some or all of the sensors 6 are embedded into each of the platform 28, the robotic positioning member 25, and the robotic end effector 10 with the system controller 4 being able to communicate with each of these and receive data therefrom.

In this example, the platform 28 can include a computing device that can communicate with and control the platform 28 and its components to position the robotic positioning member 25 and the robotic end effector 10 in close proximity to an article to be acquired using macro positioning movements. For example, the platform 28 can comprise a mobile vehicle that can be manipulated (e.g., driven, steered, etc.) to bring and position the robotic positioning member 25 and the robotic end effector 10 in close proximity to an article to be acquired. In certain examples, the computing device within the platform 28 can use one or more of the sensors 6 to perceive the operating environment and locate critical landmarks, objects, etc., such as a stack of articles to be acquired and managed, other objects that might be impeding or blocking a route of the platform 28, etc. The computing device of the platform 28 can operate the platform 28 autonomously or receive inputs from a manual control interface to allow an operator to manually manipulate the platform 28.

In this example, as discussed above, the robotic end effector 10 can include a computing device 32 that can communicate with and control the various components of the robotic end effector 10, such as the arm 12, and support platform 16, the support bridge 17, the article interface system 18, and any sensors 30 to coordinate and control movement of these devices as a unit. The computing device 32 can also access or include at least some of the sensors 6 to evaluate the environment and manipulate one or more articles. In one example, the control system 32 can access and control optical cameras, IR cameras, LIDAR sensors, and any others to facilitate recognition and locating of one or more articles to be manages, such as a target article. For instance, the computing device 32 can receive a two dimensional (2D) image from an optical camera for processing to roughly locate an article (e.g., a target article), using common machine vision techniques, such as edge detection or blob analysis. The computing device 32 can also (or alternatively) receive three dimensional (3D) data from a stereo image provided by a pair of optical cameras configured to facilitate stereo imaging, or IR cameras. The data can be analyzed to map a precise location and orientation of the target article, as well as other articles, objects, etc. around the target article. The computing device 32 can operate as a perception system for the robotic end effector 10 to assist in acquiring a target article from a first location and releasing the target article in a specific position and orientation in a second location as discussed herein. The perception system (e.g., computing device 32 in this example) can access other sensors, such as a force sensor, a LIDAR sensor and/or a rangefinder sensor to provide additional 2D and 3D information about the surroundings and operation of the various components of the robotic end effector 10.

In this example, the robotic positioning member 25 can comprise a computing device that can communicate with and control the various components of the robotic positioning member 25, such as the articulated joints, moveable support members, and any other actuators or members, in order to position the end effector 10 to facilitate acquiring, manipulating and releasing a target article. The computing device of the robotic positioning member 25 can also access or include one or more of the sensors 6 to facilitate proper positioning, operation and control of the robotic positioning member 25 and the end effector 10.

Within the robotic article management system 2, the sensors 6 operate as perception sensors to assist one or more of the platform 28, the robotic positioning member 25 or the robotic end effector 10 in acquiring, managing (manipulating), moving, and releasing one or more articles. The system 2, for example one of the computing devices discussed above, can receive and process a combination of 2D and 3D sensor data to map the environment. For 2D sensing, high resolution color imagery can be captured with one or more optical cameras. The 2D data can then be correlated with concurrently captured 3D depth and point cloud data, captured from sensors such as multiple IR cameras, a LIDAR sensor, and/or rangefinder sensors (such as time-of-flight sensors). The 3D data can also include camera data captured by a pair of stereoscopic optical cameras, which allows for a processors to triangulate objects within an environment. As an example, detection of a target article in the form of a luggage bag can involve processing 2D image data for a large, often black, reflective rectangle using a blob analysis algorithm, and then employ an edge detection mechanism to project the sides and comers of the luggage bag. The 2D edge and corner data can then be correlated to the 3D data to project a plane for a top surface, a bottom surface, and/or a side surface of the luggage bag. Once a 3D desired plane is determined for the luggage bag, the end effector 10 can be positioned using this information to acquire the luggage bag. The perception system, operating within a computing device can use algorithms to detect the edges, corners, and other uniquely identifiably features of the target article, other articles or structures around the target article, a location or structure that is to receive the released target article, etc. to define the 3D representation of these. For instance, if the luggage bag is to be placed upon a conveyor, this allows determination of the 3D position and orientation of the conveyor with respect to the sensor(s), the robotic article management system 2, and also the acquired target article. This information can inform the end effector 10 how to move in order to place the luggage bag correctly with respect to the conveyor system and its position and orientation.

It is noted herein that any of the computing devices discussed and disclosed herein can comprise similar components and functionality as the computing device 32 illustrated in FIG. 17, and discussed above. It is also noted that any of the computing devices discussed and disclosed herein can be configured to communicate and control any of the elements of the robotic article management system 2, not just the particular components of the specific device or system in which the computing device resides. For example, the computing device of the platform 28 can also communicate and control the components of the robotic positioning member 25, and so forth. That being said, each of the various components of the robotic article management system 2, namely the platform 28, the robotic positioning member 25, the robotic end effector 10, the optional external electrical object/system 29, and the system computing device (i.e., a system controller) 4 will each comprise all of the necessary hardware and/or software components to facilitate the communication and control needed within whatever example robotic article management system is designed and implemented.

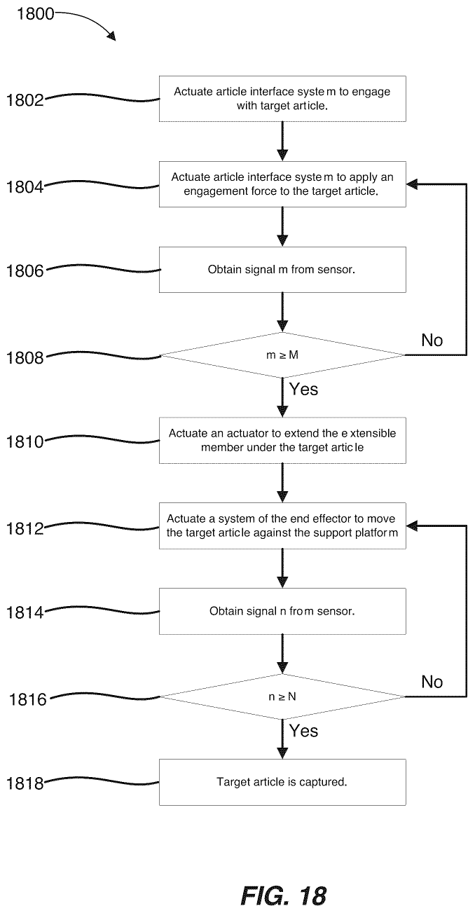

An exemplary computer-implemented method 1800, comprising instructions stored as a module 1724 in one or more of memory devices 1720 and executed by at least one processor 1712, is illustrated in flowchart form in FIG. 18. The method 1800 is control of the end effector to acquire an article. It is to be understood that the method 1800 can be executed on any of the end effectors described herein including a load, pressure, or position sensor. Each step shown in method 1800 can be carried out by a user inputting a user input at a desired time or can be carried out autonomously by the computing device 32.

At the beginning, the computer-implemented method 1800 can include a step 1802 of actuating the article interface system (e.g., article interface system 110 or any component thereof) to engage with the target article. The computer-implemented method 1800 can include a step 1804 of actuating the article interface system (e.g., article interface system 110 or any component thereof) to apply an engagement force to the target article. For example, the negative pressure source can be operated to apply a suction force to the target article via the suction assets of the article interface system in order to secure the target article to the article interface system (e.g., by causing the target article to suck to the suction assets). The computer-implemented method 1800 can include a step 1806 of obtaining a reading or signal “m” from a sensor, such as the engagement sensor 132. The sensor can be a load sensor, pressure sensor, or position sensor as described above in this disclosure. The signal m can be indicative of a load acting between the target article and the article interface system. In step 1808, the signal m can be compared to a predetermined threshold value M (e.g., predetermined engagement threshold value indicating acquisition of the target article by the suction assets (e.g., the actuatable article engagement device 112). If the signal m is less than M (e.g. No in the decision of step 1808) then the process returns to step 1804. If the signal m is greater than or equal to M (e.g. Yes in the decision of step 1808) then the process moves to step 1810.

In step 1810, the extensible member (e.g., 106B) of the support platform (e.g., 106) can be extended between the target article and the surface in support of the target article. In step 1812, a system of the end effector (e.g., any of the article interface system 110, the support bridge 101, the arm 102, the articulating arm 118, or the support platform 106) can be actuated to move the target article against the support platform. The computer-implemented method 1800 can include a step 1814 of obtaining a reading or signal “n” from a sensor. The sensor can be a load sensor, pressure sensor, or position sensor as described above in this disclosure. The signal n can be indicative of a load acting between the target article, the arm, the article interface system, and/or the support platform. In step 1816, the signal n can be compared to a predetermined threshold value N (e.g., the predetermined acquisition threshold value). If the signal n is less than N (e.g. No in the decision of step 1816) then the process returns to step 1812. If the signal n is greater than or equal to N (e.g. Yes in the decision of step 1816) then the process moves to step 1818 in which it is determined that the target article is acquired, captured, or supported with capture support sufficient to counter collective forces acting on the target article. The method 1800 can then end or the target article can then be moved or manipulated to a desired location and released by the end effector.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein can be combined with other embodiments or features described herein, this disclosure should be read to describe any such combinations that would be practicable by one of ordinary skill in the art. The use of “or” in this disclosure should be understood to mean non-exclusive or, e.g., “and/or,” unless otherwise indicated herein.

Furthermore, the described features, structures, or characteristics can be combined in any suitable manner in one or more examples. In the preceding description, numerous specific details were provided, such as examples of various configurations to provide a thorough understanding of examples of the described technology. It will be recognized, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A robotic end effector for acquiring and managing an article, the robotic end effector comprising:
a support bridge;
an arm extending away from the support bridge in a first direction, the arm comprising a first support member;
a support platform extending away from the support bridge in the first direction at a position offset from the arm to define a capture volume configured to receive a target article between the arm and the support platform; and
an article interface system supported by the arm, and comprising an actuatable article engagement device operable to interface with the target article to facilitate movement of the target article.

2. The robotic end effector of claim 1, further comprising a robotic positioning member interface that facilitates coupling the robotic end effector to an end effector interface of a robotic positioning member.

3. The robotic end effector of claim 1, wherein the article interface system further comprises a negative pressure source, and wherein the actuatable article engagement device further comprises:
a carriage coupled to the arm; and
one or more suction assets coupled to the carriage, the suction assets being configured to be in pneumatic communication with the negative pressure source and operable to facilitate generation of a suction force at each of the one or more suction assets.

4. The robotic end effector of claim 3, wherein the suction force is sufficient to facilitate separation of at least a portion of the target article from a support surface beneath the target article to provide a gap between the target article and the support surface.

5. The robotic end effector of claim 3, wherein each of the one or more suction assets comprises a cupped receptacle in pneumatic communication with the negative pressure source.

6. The robotic end effector of claim 5, wherein each of the one or more suction assets comprises a compliant vertical skirt extending from an edge of the cupped receptacle configured to engage with a surface of the target article.

7. The robotic end effector of claim 6, wherein each of the one or more suction assets further comprises a compliant horizontal skirt made of a compliant material and disposed at an edge of the cupped receptacle to at least partially surround the compliant vertical skirt.

8. The robotic end effector of claim 1, wherein the article interface system further comprises a valve system associated with the one or more suction assets, the valve system comprising a valve and a sensor, and being operable to shut off airflow in the one or more suction assets upon the one or more suction assets applying a suction force to the target article that is less than a pre-determined threshold suction force.

9. The robotic end effector of claim 1, wherein the support bridge comprises a plurality of lift members comprising at least a first lift member and a second lift member moveable relative to one another.

10. The robotic end effector of claim 9, wherein the support bridge further comprises an actuatable joint operable to facilitate movement of the first lift member relative to the second lift member.

11. The robotic end effector of claim 1, wherein the actuatable article engagement device is moveable relative to the first support member of the arm.

12. The robotic end effector of claim 11, wherein the arm further comprises an actuatable joint operable to facilitate movement of the actuatable article engagement device relative to the first support member, the actuatable joint comprising an actuator.

13. The robotic end effector of claim 12, wherein the actuator is operable in a vibration mode.

14. The robotic end effector of claim 12, wherein the article interface system further comprises a negative pressure source, and wherein the actuatable article engagement device further comprises:
a carriage coupled to the first support member; and
one or more suction assets coupled to the carriage, the suction assets being configured to be in pneumatic communication with the negative pressure source operable to facilitate generation of a suction force at each of the one or more suction assets, wherein the suction assets are operable to apply the suction force to the target article.

15. The robotic end effector of claim 1, wherein the actuatable article engagement device comprises an articulating arm moveably coupled to the first support member of the arm at a first actuatable joint, the first actuatable joint being operable to facilitate relative movement between the first support member and the articulating arm in at least one degree of freedom.

16. The robotic end effector of claim 15, wherein the article interface system further comprises a negative pressure source, and wherein the actuatable article engagement device further comprises:
a carriage coupled to the articulating arm; and
one or more suction assets coupled to the carriage, the suction assets being configured to be in pneumatic communication with the negative pressure source operable to facilitate generation of a suction force at each of the one or more suction assets, wherein the suction assets are operable to apply the suction force to the target article generated by the negative pressure source.

17. The robotic end effector of claim 1, wherein the support platform comprises a tapered leading edge configured to facilitate insertion of the support platform between the target article and a surface in support of the target article.

18. The robotic end effector of claim 1, wherein the support platform comprises one or more rollers rotatably coupled thereto to facilitate movement of the target article relative to the support platform.

19. The robotic end effector of claim 18, wherein the one or more rollers of the support platform comprise a leading-edge roller supported on a leading edge of the support platform.

20. The robotic end effector of claim 18, wherein the one or more rollers of the support platform comprises one or more upper rollers extending from an upper surface of the support platform configured to engage with the target article.

21. The robotic end effector of claim 20, wherein the one or more rollers of the support platform comprises one or more lower rollers extending from a lower surface of the support platform opposite to the upper surface and configured to engage with the surface in support of the target article.

22. The robotic end effector of claim 21, wherein the one or more rollers comprises at least one of a wheel-type roller or a belt-type roller.

23. The robotic end effector of claim 18, wherein the one or more rollers comprise at least one of powered or passive rollers.

24. The robotic end effector of claim 1, wherein the support platform comprises a surface configuration that biases the target article toward the support bridge.

25. The robotic end effector of claim 1, wherein the support platform comprises a stationary member coupled to the support bridge and an extensible member moveably coupled to the stationary member and operable to extend and retract relative to the stationary member.

26. The robotic end effector of claim 25, wherein the support platform further comprises an actuatable joint operable to facilitate movement of the extensible member relative to the stationary member to facilitate insertion of the extensible member between the target article and a surface in support of the target article, the actuatable joint comprising an actuator.

27. The robotic end effector of claim 26, wherein the actuator is operable in a vibration mode.

28. The robotic end effector of claim 25, wherein the extensible member comprises a tapered leading edge configured to facilitate insertion of the support platform between the target article and a surface in support of the target article.

29. The robotic end effector of claim 25, wherein the extensible member of the support platform comprises one or more rollers rotatably coupled thereto to facilitate insertion of the support platform between the target article and a surface in support of the target article.

30. The robotic end effector of claim 29, wherein the one or more rollers of the extensible member comprise a leading edge roller supported on a leading edge of the extensible member to facilitate insertion of the extensible member between the target article and a surface in support of the target article.

31. The robotic end effector of claim 29, wherein the one or more rollers of the extensible member comprises one or more upper rollers extending from an upper surface of the extensible member configured to engage with the target article.

32. The robotic end effector of claim 29, wherein the one or more rollers of the extensible member comprises one or more lower rollers extending from a lower surface of the support platform opposite to the upper surface and configured to engage with the surface in support of the target article.

33. The robotic end effector of claim 29, wherein the one or more rollers of the extensible member comprises at least one of a wheel-type roller and a belt-type roller.

34. The robotic end effector of claim 25, further comprising a vibrational actuator operably supported on at least one of the arm, the support bridge, the support platform, or the extensible member of the support platform, the vibrational actuator being operable to vibrate the extensible member during extension of the extensible member relative to the stationary member of the support platform to facilitate insertion of the extensible member between the target article and the surface in support of the target article.

35. The robotic end effector of claim 34, wherein the vibrational actuator is operable to vibrate the support platform with a vibratory waveform operable to vibrate the target article in a direction on to the support platform during capture of the target article, and the vibrational actuator is operable to vibrate the support platform with a vibratory waveform configured to vibrate the target article in a direction off of the support platform during release of the target article.

36. The robotic end effector of claim 34, wherein the vibrational actuator is sized and operable to both extend the extensible member relative to the stationary member and to vibrate the extensible member during extension of the extensible member relative to the stationary member.

37. The robotic end effector of claim 25, wherein at least one of the stationary member or the extensible member of the support platform comprises a surface configuration that is configured to bias the target article toward the support bridge.

38. The robotic end effector of claim 37, wherein the surface configuration further biases the target article toward a longitudinal center of the support platform with respect to lateral edges of the support platform.

39. The robotic end effector of claim 37, wherein the support platform comprises a plurality of surface assets that impart the surface configuration, wherein the plurality of surface assets are oriented in a first direction to bias the target article in the first direction.

40. The robotic end effector of claim 37, wherein the support platform comprises a plurality of surface assets that impart the surface configuration, the plurality of surface assets comprising at least a first surface asset oriented in a first direction to bias the target article in the first direction and a second surface asset oriented in a second direction different from the first direction to bias the target article in the second direction.

41. The robotic end effector of claim 37, wherein the surface configuration is configured such that vibration of the support platform biases the target article toward the support bridge.

42. The robotic end effector of claim 37, wherein the surface configuration is further directionally biased from one or more lateral edges of the support platform toward a center of the support bridge such that vibration of the support platform creates a net collection of displacements of the target article toward the center of the support platform.

43. The robotic end effector of claim 1, further comprising a load sensor associated with at least one of the support platform or the arm, wherein the load sensor is operable to measure an engagement force acting between the article and the support platform.

44. The robotic end effector of claim 3, further comprising a sensor associated with at least one of the suction assets, wherein the sensor is operable to measure a suction force acting between the target article and at least one of the suction assets.

45. The robotic end effector of claim 1, wherein the support platform comprises two or more extensible members moveably coupled to the stationary member, wherein at least two of the two or more extensible members are operable to move independently of each other relative to the stationary member.

46. The robotic end effector of claim 45, wherein each of the two or more extensible members comprise at least one roller coupled thereto and operable to facilitate insertion of the extensible members between the target article and a surface in support of the target article.

47. The robotic end effector of claim 1, further comprising an actuatable joint at which the arm is rotatably coupled to the support bridge such that the arm is rotatable about an axis extending in the first direction from the support bridge.

48. A robotic system for acquiring and managing an article, the robotic system comprising:
a robot comprising a robotic positioning member having an end effector interface; and
the robotic end effector of claim 1 supported on the robotic positioning member of the robot, the robotic end effector comprising a robotic positioning member interface that engages with the end effector interface of the robotic positioning member of the robot.

49. A method for acquiring an article, the method comprising:
bringing a target article and a robotic end effector for acquiring and managing the target article into proximity with each other, the robotic end effector comprising a support bridge, an arm extending away from the support bridge in a first direction, the arm comprising a first support member, and a support platform extending away from the support bridge in the first direction at a position offset from the arm to define a capture volume configured to receive the target article between the arm and the support platform;
operating an article interface system supported by the arm, the article interface system comprising an actuatable article engagement device operable to interface with the target article to facilitate movement of the target article, wherein operating the article interface system comprises:
moving the actuatable article engagement device from first position to a second position relative to the target article in which an article interface surface of the actuatable article engagement device engages with the target article;
actuating the actuatable article engagement device to act upon the target article to facilitate capture and a state of acquisition of the target article, in which the forces acting on the target article from the end effector are sufficient to counter collective forces acting on the target article.

50. The method of claim 49, wherein the article interface system further comprises a negative pressure source, and wherein the actuatable article engagement device further comprises a carriage coupled to the arm and one or more suction assets coupled to the carriage, the method further comprising:
operating a negative pressure source in pneumatic communication with the one or more suction assets to generate a suction force at each of the one or more suction assets to be applied to the target article to secure the target article to the article interface system via the suction assets and the suction force generated by the negative pressure source.

51. The method of claim 50, further comprising:
measuring the suction force between the target article and the suction assets using a sensor operably supported on at least one of the arm, one or more of the suction assets, or the carriage, to determine a state of suction between the target article and the suction assets.

52. The method of claim 49, further comprising
extending an extensible member of the support platform relative to a stationary member of the support platform by actuation of an actuatable joint operable to move the extensible member relative to the stationary member, the actuatable joint comprising an actuator; and
inserting the extensible member between the target article and a surface in support of the target article to transition the target article from being supported by the surface to being supported by the extensible member.

53. The method of claim 52, further comprising operating the actuator in a vibration mode.

54. The method of claim 52, further comprising:
prior to inserting the extensible member, operating a negative pressure source to apply a suction force to the target article via one or more suction assets and to facilitate separation of the target article from the surface to provide a gap between the target article and the surface in which the extensible member can be inserted.

55. The method of claim 51, further comprising:
comparing the measured suction force to a predetermined threshold value indicating acquisition of the target article by the suction assets; and
extending an extensible member of the support platform in a degree of freedom relative to a stationary member of the support platform by actuation of an actuatable joint operable to move the extensible member relative to the stationary member; and
inserting the extensible member between the target article and a surface in support of the target article, upon the measured suction force reaching a value that is greater than or equal to the predetermined threshold value, to transition the target article from being supported by the surface to being supported by the extensible member.

56. The method of claim 49, further comprising moving the target article against the support platform by moving a first lift member of the support bridge relative to a second lift member of the support bridge by operation of an actuatable joint coupling the first lift member and the second lift member together to facilitate movement of the first lift member relative to the second lift member.

57. The method of claim 49, further comprising:
measuring a force between the target article and the support platform using a load sensor operably supported on at least one of the arm, the support bridge, or the support platform, to determine a state of acquisition of the target article based on comparing the force to a predetermined threshold value indicating acquisition of the target article on the support platform.

58. The method of claim 49, further comprising a vibrating the support platform.

59. The method of claim 49, further comprising:
operating a vibrational actuator to vibrate the support platform with a vibratory waveform operable to vibrate the target article in a direction onto the support platform during capture of the target article; and
operating the vibrational actuator to vibrate the support platform with a vibratory waveform configured to vibrate the target article in a direction off of the support platform during release of the target article.

60. The method of claim 59, further comprising operating the vibrational actuator to both extend the extensible member relative to the stationary member and to vibrate the extensible member during extension of the extensible member relative to the stationary member.

61. The method of claim 49, wherein the actuatable article engagement device is moveable relative to the first support member of the arm, the method further comprising:
moving the actuatable article engagement device relative to the first support member of the arm, wherein the first support member and the actuatable article engagement device are coupled to one another at an actuatable joint operable to facilitate movement of the actuatable article engagement device relative to the first support member.

62. The method of claim 50, wherein the carriage of the actuatable article engagement device is moveably coupled to the first support member, the method further comprising:
moving the actuatable article engagement device relative to the first support member to move the actuatable article engagement device from a first position to a second position, in which the suction assets are positioned adjacent the target article to facilitate application of a suction force to the target article via the suction assets.

63. The method of claim 49, further comprising moving the actuatable article engagement device from the second position to the first position by moving the target article toward the support bridge by retracting the actuatable article engagement device relative to the first support member of the arm, wherein, in the first position, the article interface system is positioned such that the target article is adjacent to the support platform.

64. The method of claim 49, further comprising:
measuring a force between the target article and the support platform using a load sensor operably supported on at least one of the arm, the support bridge, or the support platform, to determine a state of acquisition of the target article based on comparing the force to a predetermined threshold value indicating acquisition of the target article on the support platform.

65. The method of claim 64, further comprising:
comparing the measured force between the target article and the support platform to a predetermined threshold value indicating sufficient force between the target article and the support platform to counter collective forces acting on the target article;
moving the actuatable article engagement device from the second position to the first position in which the target article moves toward the support bridge by retracting the actuatable article engagement device relative to the first support member of the arm in response to the measured force being greater than or equal to the predetermined threshold value.

66. The method of claim 50, wherein the arm is rotatably coupled to the support bridge at an actuatable joint such that the arm is rotatable about an axis extending in the first direction from the support bridge, the method further comprising:
moving the arm relative to the support bridge to align the suction assets with the target article to facilitate application of a suction force to the target article via the suction assets.

67. The method of claim 50, further comprising:
identifying a safe level of engagement force for acquiring the target article; and
limiting an actuator operable to actuate the actuatable article engagement device to act upon the target article at or below the identified safe level of engagement force;
wherein limiting the actuator to operate at the safe level of engagement force comprises one or more of: selecting one or more actuators for the end effector that is configured to operate at or below the safe level, mechanically limiting the actuator to operate at or below the safe level, pneumatically limiting the actuator to operate at or below the safe level, hydraulically limiting the actuator to operate at or below the safe level, or electronically limiting the actuator to operate at or below the safe level.
